(19) United States
(12) Patent Application Publication
(10) Pub. No.: US 2026/0300383 A1
(43) Pub. Date: Oct. 1, 2026

(54) MULTI-MODALITY RETRIEVAL MODEL GENERATION METHOD AND APPARATUS, DEVICE, AND STORAGE MEDIUM

(71) Applicant: Tencent Technology (Shenzhen) Company Limited, Shenzhen (CN)

(72) Inventors: Xinwei LONG, Shenzhen (CN); Jiali ZENG, Shenzhen (CN); Fandong MENG, Shenzhen (CN); Bo Wen ZHOU, Shenzhen (CN)

(73) Assignee: Tencent Technology (Shenzhen) Company Limited, Shenzhen (CN)

(21) Appl. No.: 19/688,170

(22) Filed: May 26, 2026

Related U.S. Application Data
(63) Continuation of application No. PCT/CN2025/080014, filed on Feb. 28, 2025.

(30) Foreign Application Priority Data
Feb. 29, 2024 (CN) 202410234648.9

(51) Int. Cl. G06F 16/535

(52) U.S. Cl. CPC G06F 16/535

(57) ABSTRACT

The multi-modality retrieval model generation method includes: performing feature recognition on first sample image modality data through a prefix vector module to obtain a first image prefix vector; generating, by a modality recognition module, a first retrieval character according to the first image prefix vector, the first sample image modality data, and first sample text modality data; obtaining, by a constraint decoding module, a first sample retrieval result associated with the first retrieval character from a pre-generated database; and adjusting, according to a first reference retrieval result and a first sample retrieval result, model parameters corresponding to the prefix vector module and the constraint decoding module respectively to obtain an adjusted retrieval model. The present disclosure can improve training efficiency of a multi-modality retrieval model.

### RELATED APPLICATION

This application is a continuation of and claims the benefit of priority to PCT Application No. PCT/CN2025/080014, filed Feb. 28, 2025, and entitled MULTI-MODAL RETRIEVAL MODEL GENERATION METHOD AND APPARATUS, DEVICE, AND STORAGE MEDIUM, which is based on and claims priority to Chinese Patent Application No. 202410234648.9, entitled “DATA PROCESSING METHOD AND APPARATUS, DEVICE, AND STORAGE MEDIUM” filed with the China National Intellectual Property Administration on Feb. 29, 2024. The above applications are incorporated herein by reference in their entireties.

### FIELD OF THE TECHNOLOGY

The present disclosure relates to the field of computer technologies, and in particular, to a multi-modality retrieval model generation method and apparatus, a device, and a storage medium.

### BACKGROUND OF THE DISCLOSURE

With the development of Internet technology and the continuous growth of network data scale, modality data retrieval technologies can meet users' data retrieval demands such as question-answer and dialog. Recently, modality data retrieval technologies have shown a trend from single-modality to multi-modality including image and text. A multi-modality retrieval model capable of accurately performing single-modality or multi-modality data retrieval can bring great convenience to users' data retrieval requirements.

Currently, during the training process of the multi-modality retrieval model, all model parameters in the multi-modality retrieval model need to be adjusted according to a model loss of the multi-modality retrieval model. Therefore, large-scale high-quality sample data is required for training, resulting in high model training cost and low training efficiency of the multi-modality retrieval model.

### SUMMARY

Embodiments of the present disclosure provide a multi-modality retrieval model generation method and apparatus, a device, and a storage medium, which can improve the training efficiency of a multi-modality retrieval model and reduce the training cost of the multi-modality retrieval model.

An aspect of embodiments of the present disclosure provides a multi-modality retrieval model generation method, including:
obtaining an initial retrieval model, the initial retrieval model including a modality recognition module, a prefix vector module, and a constraint decoding module;
obtaining a first sample retrieval request, the first sample retrieval request including first sample text modality data and first sample image modality data mutually associated, and including a first reference retrieval result pre-labeled for the first sample retrieval request;
performing, by the prefix vector module, feature recognition on the first sample image modality data to obtain a first image prefix vector;
generating, by the modality recognition module, a first retrieval character according to the first image prefix vector, the first sample image modality data, and the first sample text modality data;
obtaining, by the constraint decoding module, a first sample retrieval result associated with the first retrieval character from a pre-generated database; and
adjusting, according to the first reference retrieval result and the first sample retrieval result, model parameters corresponding to the prefix vector module and the constraint decoding module respectively to obtain an adjusted retrieval model.

An aspect of embodiments of the present disclosure provides a multi-modality retrieval model generation apparatus, including:
an obtaining module, configured to obtain an initial retrieval model and obtain a first sample retrieval request, the initial retrieval model including a modality recognition module, a prefix vector module, and a constraint decoding module, and the first sample retrieval request including first sample text modality data and first sample image modality data mutually associated, and including a first reference retrieval result pre-labeled for the first sample retrieval request;
a first generation module, configured to perform, by the prefix vector module, feature recognition on the first sample image modality data to obtain a first image prefix vector;
a second generation module, configured to generate, by the modality recognition module, a first retrieval character according to the first image prefix vector, the first sample image modality data, and the first sample text modality data;
a first retrieval module, configured to obtain, by the constraint decoding module, a first sample retrieval result associated with the first retrieval character from a pre-generated database; and
an adjustment module, configured to adjust, according to the first reference retrieval result and the first sample retrieval result, model parameters corresponding to the prefix vector module and the constraint decoding module respectively to obtain an adjusted retrieval model.

An aspect of embodiments of the present disclosure provides a computer-readable storage medium. The computer-readable storage medium has a computer program stored therein, the computer program being adapted to be loaded and executed by a processor, so that a computer device including the processor performs the method provided in the embodiments of the present disclosure.

An aspect of embodiments of the present disclosure provides a computer program product or computer program. The computer program product or computer program includes computer instructions, and the computer instructions are stored in a computer-readable storage medium. A processor of a computer device reads the computer instructions from the computer-readable storage medium, and the processor executes the computer instructions, so that the computer device performs the method provided in the embodiments of the present disclosure.

In the embodiments of the present disclosure, the initial retrieval model has strong content understanding capability and language generation capability, and has great processing potential for data retrieval. Therefore, during the training process of the initial retrieval model, model parameters of the original modules (e.g., the modality recognition module) in the initial retrieval model remain unchanged. Only lightweight fine-tuning of the model parameters of the prefix vector module and the constraint decoding module is required, so that the prefix vector module and the constraint decoding module learn knowledge about data retrieval, to obtain the multi-modality retrieval model. In this way, the adjustment of the model parameters can be reduced, the training cost of the multi-modality retrieval model can be reduced, and the training efficiency of the multi-modality retrieval model can be improved. By keeping the model parameters of the original modules (e.g., modality recognition) in the initial retrieval model unchanged, the content understanding and generation capabilities of the initial retrieval model are reused, avoiding the problem of catastrophic forgetting of a generative language model caused by the update of training data, thereby ensuring the training stability of the multi-modality retrieval model. During the training process of the initial retrieval model, only lightweight fine-tuning of the constraint decoding module and the prefix vector module is required. Therefore, a large amount of sample data is not needed, which avoids the problem of low model training accuracy caused by insufficient sample data. To be specific, this is beneficial to improving the accuracy of model training, thereby improving the retrieval accuracy of a multi-modality model during the retrieval process.

### BRIEF DESCRIPTION OF THE DRAWINGS

To describe the technical solutions in embodiments of the present disclosure or the related art more clearly, the following briefly introduces the accompanying drawings required for describing the embodiments or the related art. Apparently, the accompanying drawings in the following description show only some embodiments of the present disclosure, and a person of ordinary skill in the art may still derive other drawings from these accompanying drawings without creative efforts.

FIG. 1 is an example schematic structural diagram of a multi-modality retrieval model generation system according to an embodiment of the present disclosure.

FIG. 2 is an example schematic diagram of a training manner of a multi-modality classification model according to an embodiment of the present disclosure.

FIG. 3 is an example schematic flowchart of a multi-modality retrieval model generation method according to an embodiment of the present disclosure.

FIG. 4 is an example schematic diagram of obtaining a first retrieval character according to an embodiment of the present disclosure.

FIG. 5 is an example schematic diagram of retrieving a first sample retrieval result based on a first retrieval character according to an embodiment of the present disclosure.

FIG. 6 is an example schematic diagram of generative retrieval performed by a multi-modality retrieval model according to an embodiment of the present disclosure.

FIG. 7 is an example schematic flowchart of a multi-modality retrieval model generation method according to an embodiment of the present disclosure.

FIG. 8 is an example schematic structural diagram of a multi-modality retrieval model generation apparatus according to an embodiment of the present disclosure.

FIG. 9 is an example schematic diagram of a computer device according to an embodiment of the present disclosure.

### DESCRIPTION OF EMBODIMENTS

The following clearly and completely describes the technical solutions in the embodiments of the present disclosure with reference to the accompanying drawings in the embodiments of the present disclosure. Apparently, the described embodiments are some of the embodiments of the present disclosure rather than all of the embodiments. All other embodiments obtained by a person of ordinary skill in the art based on the embodiments of the present disclosure without creative efforts shall fall within the protection scope of the present disclosure.

The present disclosure relates to the technical field of artificial intelligence. Specifically, embodiments of the present disclosure may obtain a multi-modality retrieval model by training an initial retrieval model added with a prefix vector module and a constraint decoding module, thereby reducing the model training cost and improve the training efficiency of the multi-modality retrieval model. Meanwhile, the multi-modality retrieval model may be configured for single-modality data retrieval or multi-modality data retrieval, to improve the accuracy and efficiency of data retrieval.

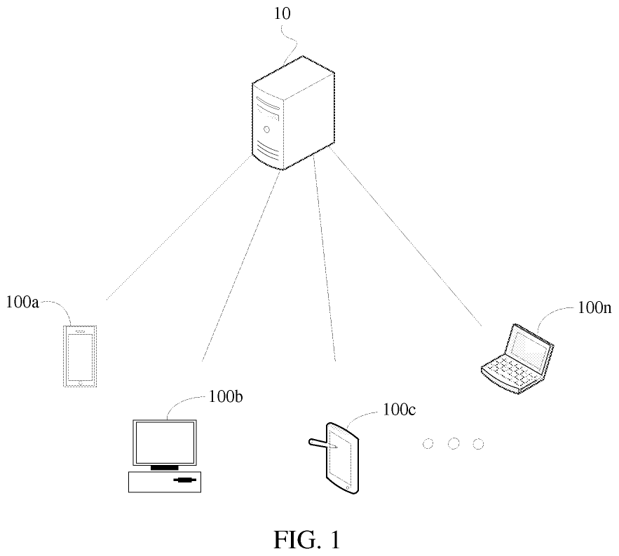

Referring to FIG. 1, FIG. 1 is a schematic structural diagram of a multi-modality retrieval model generation system according to an embodiment of the present disclosure. As shown in FIG. 1, the multi-modality retrieval model generation system may include a server 10 and a terminal device cluster. The terminal device cluster may include one or more terminal devices. A quantity of terminal devices is not limited herein. As shown in FIG. 1, a terminal device 100a, a terminal device 100b, a terminal device 100c, . . . , and a terminal device 100n may be specifically included. As shown in FIG. 1, the terminal device 100a, the terminal device 100b, the terminal device 100c, . . . , and the terminal device 100n may be in network connection with the server 10 separately, so that each terminal device may exchange data with the server 10 by using the network connection. In particular, the terminal device 100a, the terminal device 100b, the terminal device 100c, . . . , and the terminal device 100n may communicate with each other through a direct network connection. To be specific, point-to-point communication may be implemented among the terminal devices. In other words, when data interaction is required between every two terminal devices, one terminal device (e.g., a transmitting terminal device) may directly transmit data to another terminal device (e.g., a receiving terminal device).

Each terminal device in the terminal device cluster may include: a smart terminal having a data processing function such as a smartphone, a tablet computer, a laptop computer, a desktop computer, a smart voice interaction device, a smart home appliance (e.g., a smart television), a wearable device, or an on-board terminal. Each terminal device in the terminal device cluster as shown in FIG. 1 may be installed with an application having a modality data processing function. When the application runs in each terminal device, the application may perform data interaction with the server 10 shown in FIG. 1 respectively. For example, the application may specifically include a multi-modality feature extraction application, a multi-modality retrieval application, and the like. For ease of understanding, in the embodiments of the present disclosure, one terminal device may be selected from the plurality terminal devices shown in FIG. 1 as a target terminal device. For example, in the embodiments of the present disclosure, the terminal device 100a shown in FIG. 1 may be used as a target terminal device, and an application having a modality data processing function may be installed in the target terminal device. In this case, the target terminal device may implement data interaction with the server 10 through the application in the target terminal device.

As shown in FIG. 1, the server 10 may be a device that provides a background service for the application in the terminal device. The server 10 may be an independent physical server, or a server cluster or a distributed system including a plurality of physical servers, or may alternatively be a cloud server that provides a cloud service, a cloud database, cloud computing, a cloud function, cloud storage, a network service, cloud communication, a middleware service, a domain name service, a security service, a content delivery network (CDN), and a basic cloud computing service such as big data and an artificial intelligence platform.

The multi-modality retrieval model generation system based on FIG. 1 may be applied to a training scenario of a multi-modality retrieval model. Multi-modality may be configured for indicating that input data of the multi-modality retrieval model has a plurality of data forms. To be specific, the multi-modality retrieval model may be configured to process data of a plurality of data forms. The data forms may include a speech form, an image form, a video form, a text form, and the like. Alternatively, multi-modality is configured for indicating that the input data of the multi-modality retrieval model includes data from a plurality of information sources. To be specific, the multi-modality retrieval model may be configured to process data from a plurality of information sources. The information sources may include different sensors such as a radar, an infrared sensor, an accelerometer, and a camera.

The multi-modality retrieval model in the embodiments of the present disclosure may be configured for data retrieval of a single modality (e.g., any one modality such as a text modality or an image modality). For example, when the multi-modality retrieval model is applied to single-modality data retrieval, a text retrieval request inputted by a business object (e.g., text modality data, such as a text question) may be subjected to data retrieval through the multi-modality retrieval model, to obtain retrieval document data corresponding to the text retrieval request. The retrieval document data corresponding to the text modality retrieval request may be used as an answer to the text retrieval request, and the corresponding retrieval document data may be displayed to the business object.

The multi-modality retrieval model in the embodiments of the present disclosure may be configured for data retrieval of multiple modalities (e.g., any one modality such as a text modality or an image modality). For example, when the multi-modality retrieval model is applied to multi-modality data retrieval, a multi-modality retrieval request of a business object (e.g., multi-modality data, such as a combination of image modality data and text modality data) may be subjected to data retrieval through the multi-modality retrieval model, to obtain retrieval document data corresponding to the multi-modality retrieval request, and the retrieval document data corresponding to the multi-modality retrieval request may be displayed to the business object.

The initial retrieval model may be obtained by adding a prefix vector module and a constraint decoding module to a trained generative language model. The trained generative language model may refer to a generative language model that is pre-trained and satisfies a convergence condition. The convergence condition may mean that a model loss is less than or equal to a loss threshold, or that a number of model training is greater than or equal to a number threshold. The trained generative language model has strong content understanding capability and language generation capability, and has great processing potential for data retrieval. The generative language model includes a modality recognition module. The modality recognition module may be configured to perform image feature recognition on first sample image modality data and text feature recognition on first sample text modality data, to generate a retrieval character associated with a retrieval request. The retrieval character is configured for retrieving corresponding retrieval document data. Specifically, the modality recognition module may include a visual representation sub-module configured to perform image feature recognition on image modality data, and a language recognition sub-module configured to perform text feature recognition on text modality data.

The visual representation sub-module may include N Transformer layer structures, for performing image feature recognition on the first sample image modality data to obtain a visual representation vector of the first sample image modality data. Transformer is a neural network that learns context and thus meaning by recognizing relationships in input sequence data. The language recognition sub-module may be a large language model structure. A large language model is a statistical model for predicting probabilities of a sequence of words in a text sequence, and trains large-scale text data to understand language and predict a next word in the sequence. The language recognition sub-module may include network structures such as a generative pre-training (GPT) network structure (a natural language processing model based on deep learning) and a bidirectional encoder representations from transformer (BERT) network structure (an unsupervised pre-trained language model for natural language processing tasks).

The embodiments of the present disclosure may add a prefix vector module and a constraint decoding module associated with data retrieval to a trained generative language model. In this way, an initial retrieval model may include a modality recognition module, a prefix vector module, and a constraint decoding module. By training the added generative language model and keeping model parameters of an original module in the initial retrieval model (e.g., modality recognition) unchanged, the content understanding and generation capabilities of the initial retrieval model are reused, so that the prefix vector module and the constraint decoding module learn knowledge about data retrieval, and a multi-modality retrieval model is obtained. The embodiments of the present disclosure may adjust and improve image feature recognition of image modality data performed by the modality recognition module through the prefix vector module, so as to improve accuracy of the image feature recognition of the image modality data performed by the modality recognition module.

A sample retrieval request refers to a retrieval request for training the added generative language model. The retrieval request may include single-modality data (e.g., a text question or a language question) or multi-modality data (e.g., a multi-modality question combining text and images or a multi-modality question combining text and video). That first sample text modality data and first sample image modality data have an association relationship may mean that the first sample text modality data is a text question generated for the first sample image modality data. In other words, the first sample text modality data is configured for indicating retrieval of a part of data in the first sample image modality data. For example, the first sample image modality data is an image including a motorcycle. The first sample text modality data may be configured for retrieving the motorcycle in the first sample image modality data (e.g., retrieving a brand of the motorcycle in the first sample image modality data).

Specifically, taking training the added generative language model by using a first sample retrieval request including the first sample text modality data and the first sample image modality data that have an association relationship as an example, the prefix vector module may generate a first image prefix vector according to the first sample image modality data. The modality recognition module may generate a first retrieval character according to the first image prefix vector, the first sample image modality data, and the first sample text modality data. The first image prefix vector may be used as a prefix of an image modality feature of the first sample image modality data, so as to accurately extract the image modality feature of the first sample image modality data. The constraint decoding module may retrieve a first sample retrieval result associated with the first sample retrieval request according to the first retrieval character inputted by the modality recognition module. To be specific, the first sample retrieval result is a retrieval result outputted by the initial retrieval model according to the first sample retrieval request.

Further, the initial retrieval model may be trained according to a difference between the first sample retrieval result outputted by the initial retrieval model (e.g., a retrieval result outputted by the initial retrieval model) and a first reference retrieval result (e.g., a labeled retrieval result). Specifically, since the modality recognition module has been trained, model parameters corresponding to the modality recognition module are frozen. In this way, adjustment of the model parameters can be reduced, and a problem of catastrophic forgetting of the modality recognition module (e.g., disordered adjustment of the model parameters in the modality recognition module) caused by update of training data can be avoided, thereby ensuring high efficiency and stability of model training.

Furthermore, model parameters corresponding to the prefix vector module and the constraint decoding module in the initial retrieval model may be respectively adjusted according to the first reference retrieval result and the first sample retrieval result, to obtain a multi-modality retrieval model. In this way, only model parameters of the newly added prefix vector module and constraint decoding module are adjusted, which can reduce a parameter adjustment range of the added initial retrieval model, and can also ensure that the trained multi-modality retrieval model may accurately perform single-modality data retrieval or multi-modality data retrieval, thereby improving training efficiency and training stability of the multi-modality retrieval model.

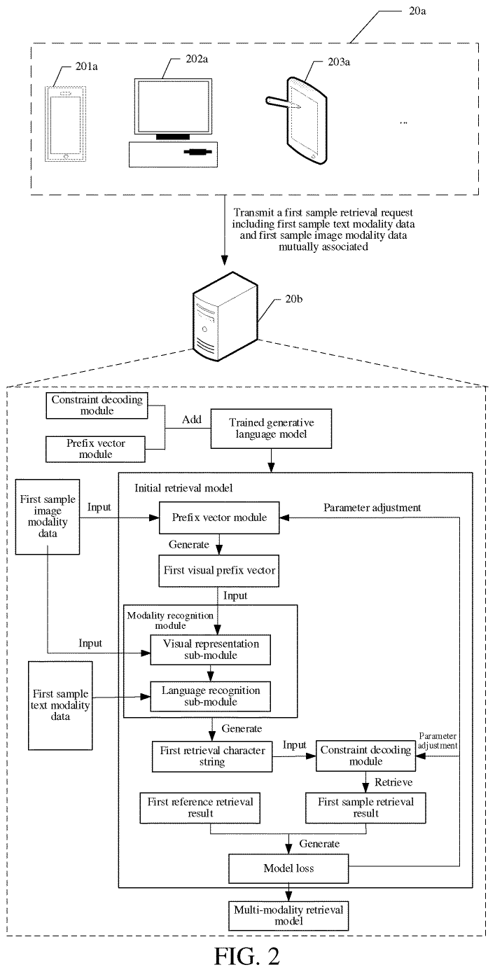

As shown in FIG. 2, FIG. 2 is a schematic diagram of training a multi-modality retrieval model according to an embodiment of the present disclosure. As shown in FIG. 2, a terminal device 201a, a terminal device 202a, a terminal device 203a, and the like in a terminal device cluster 20a may be terminal devices of the terminal device cluster in the foregoing embodiment corresponding to FIG. 1, and a server 20b shown in FIG. 2 may be the server 10 in the foregoing embodiment corresponding to FIG. 1. As shown in FIG. 2, the terminal device 201a, the terminal device 202a, and the terminal device 203a in the terminal device cluster 20a may obtain a retrieval request inputted by a sample object, and use the retrieval request inputted by the sample object as a sample retrieval request, namely as a model training sample. A retrieval request inputted by a business object may include a single-modality retrieval request, such as a text retrieval request, an image retrieval request, a video retrieval request, or an audio retrieval request. In particular, the retrieval request inputted by the business object may alternatively include a multi-modality retrieval request. The multi-modality retrieval request may include a retrieval request composed of multi-modality data such as text modality data, image modality data, and video modality data. Each terminal device in the terminal device cluster 20a may use the obtained retrieval request including text modality data and image modality data that have an association relationship as a first sample retrieval request. The text modality data included in the first sample retrieval request is referred to as first sample text modality data, and the image modality data included in the first sample retrieval request is referred to as first sample image modality data.

The terminal device 201a, the terminal device 202a, and the terminal device 203a in the terminal device cluster 20a may transmit respective obtained first sample retrieval requests to the server 20b. The server 20b may add a prefix vector module and a constraint decoding module associated with data retrieval to a trained generative language model, to obtain an initial retrieval model. The trained generative language model may refer to a generative language model that is pre-trained and satisfies a convergence condition. The generative language model may include a modality recognition module. The modality recognition module is configured to perform image feature recognition on the first sample image modality data and text feature recognition on the first sample text modality data. The initial retrieval model includes the prefix vector module, the constraint decoding module, and the modality recognition module.

Specifically, the server 20b may input the first sample image modality data into the prefix vector module in the initial retrieval model, and generate, by the prefix vector module, a first image prefix vector according to the first sample image modality data. Meanwhile, the server 20b may input the first sample image modality data, the first sample text modality data, and the first image prefix vector into the modality recognition module.

The modality recognition module may perform feature extraction on the first sample image modality data to obtain an image modality feature vector of the first sample image modality data, may use the first image prefix vector as a prefix of the image modality feature vector, and may perform feature recognition on the first sample image modality data via the first image prefix vector and the image modality feature vector jointly, to obtain a visual representation vector corresponding to the first sample image modality data. Also, text feature recognition is performed on the first sample text modality data by the modality recognition module to obtain a text modality feature corresponding to the first sample text modality data, and then a first retrieval character is generated according to the visual representation vector and the text modality feature.

As shown in FIG. 2, the modality recognition module includes a visual representation sub-module configured to perform image feature recognition on image modality data, and a language recognition sub-module configured to perform text feature recognition on text modality data. The server 20b may input the first image prefix vector and the first sample image modality data into the visual representation sub-module, and perform image feature recognition on the first sample image modality data by the visual representation sub-module to obtain a visual representation vector. The visual representation sub-module may be pre-trained, and may accurately perform feature extraction on image modality data. Further, the visual representation vector and the first sample text modality data are inputted into the language recognition sub-module, feature extraction is performed on the first sample text modality data to obtain a text modality feature, and then association feature extraction is performed on the text modality feature and the visual representation vector to generate a first retrieval character. The language recognition sub-module may refer to a pre-trained large language model. The large language model has powerful content understanding and character generation capabilities, and has great potential for understanding complex retrieval requests. In this way, the large language model may be used as a virtual knowledge base, and the internal knowledge of the large language model may be effectively utilized.

Further, the server 20b may retrieve, by the constraint decoding module, a first sample retrieval result associated with the first sample retrieval request according to the first retrieval character, thereby improving retrieval efficiency and accuracy of the first sample retrieval result. The first sample retrieval result may be a retrieval result of the initial retrieval model for the first sample retrieval request. The server 20b may obtain a first reference retrieval result. The first reference retrieval result may be a correct retrieval result corresponding to the first sample retrieval request. The server 20b may determine a model loss of the initial retrieval model according to the first sample retrieval result and the first reference retrieval result. Since the modality recognition module is pre-trained and satisfies a convergence condition, to be specific, the modality recognition module has been trained, model parameters corresponding to the modality recognition module may be frozen. To be specific, no parameter adjustment is performed on the model parameters corresponding to the modality recognition module. In this way, adjustment of the model parameters can be reduced, and a problem of catastrophic forgetting of the modality recognition module caused by update of training data can be avoided, thereby ensuring high efficiency and stability of model training.

The server 20b may adjust the model parameters corresponding to the prefix vector module and the constraint decoding module in the initial retrieval model according to the model loss, until the initial retrieval model satisfies the convergence condition, to obtain the multi-modality retrieval model. Since the modality recognition module has been trained and may be configured to perform feature recognition on image modality data and text modality data respectively, it is unnecessary to adjust the model parameters in the modality recognition module. The multi-modality retrieval model for modality data retrieval is obtained only by adjusting the model parameters in the prefix vector module (e.g., a lightweight prefix fine-tuning manner) and the model parameters in the constraint decoding module. In this way, the range of model parameter adjustment can be reduced, lightweight model parameter fine-tuning can be realized, heavy training load can be reduced, and the stability of model training can be ensured. Even with limited labeled data, the internal knowledge in the pre-trained initial retrieval model can be effectively utilized to obtain a high-performance multi-modality retrieval model, and the training efficiency of the multi-modality retrieval model can be improved.

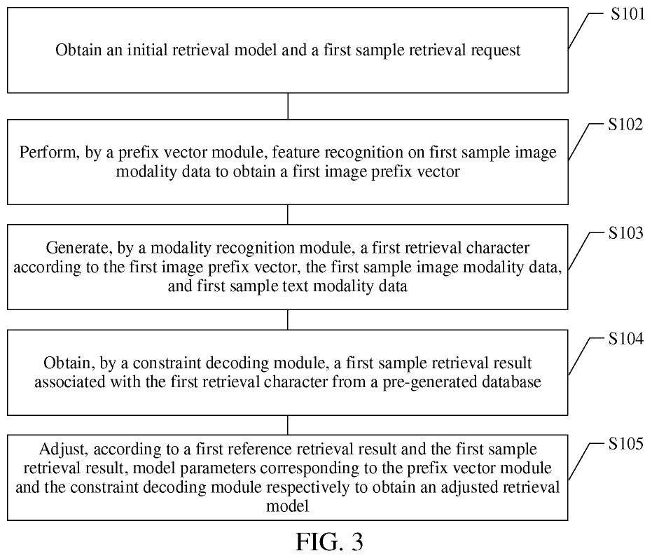

Further, referring to FIG. 3, FIG. 3 is a schematic flowchart of a multi-modality retrieval model generation method according to an embodiment of the present disclosure. As shown in FIG. 3, the method may be performed by any terminal device in FIG. 1, by the server 10 in FIG. 1, or jointly by the terminal devices and the server in FIG. 1. Devices configured to perform the multi-modality retrieval model generation method in the present disclosure may be collectively referred to as a computer device. The multi-modality retrieval model generation method may include, but is not limited to, the following operations:
S101: Obtain an initial retrieval model and a first sample retrieval request.

The first sample retrieval request includes first sample text modality data and first sample image modality data mutually associated, and includes a first reference retrieval result pre-labeled for the first sample retrieval request.

The initial retrieval model includes a modality recognition module, a prefix vector module, and a constraint decoding module. The initial retrieval model may be obtained by adding the prefix vector module and the constraint decoding module to a trained generative language model. Alternatively, the initial retrieval model may be a to-be-trained retrieval model.

The first reference retrieval result may refer to a retrieval result obtained by manually labeling the first sample image modality data and the first sample text modality data in the first sample retrieval request. To be specific, the first sample text modality data is a text question for the first sample image modality data, and the first reference retrieval result is a reference answer to the text question indicated by the first sample text modality data. For example, the first sample image modality data includes a motorcycle of brand A, and the first sample text modality data is: which brand does the motorcycle in the first sample image modality data belong to. Then the first reference retrieval result is: the motorcycle in the first sample image modality data belongs to brand A.

Specifically, the computer device may add a prefix vector module and a constraint decoding module associated with data retrieval to a trained generative language model to obtain an initial retrieval model, and train the initial retrieval model to obtain a multi-modality retrieval model for modality data retrieval. The generative language model includes a modality recognition module. The modality recognition module may be configured to perform image feature recognition on image modality data and text feature recognition on text modality data. Since the generative language model is trained (e.g., pre-trained and satisfying a convergence condition), model parameters in the modality recognition module do not need to be trained and adjusted again. Only model parameters in the prefix vector module and the constraint decoding module need to be trained and adjusted, which can reduce a range of model parameter adjustment and further improve the training efficiency of the multi-modality retrieval model. The prefix vector module may adjust and improve image feature recognition of image modality data performed by the modality recognition module (e.g., adjust and improve multi-granularity visual feature learning), so as to improve the accuracy of the image feature recognition of the image modality data performed by the modality recognition module. The constraint decoding module may accurately retrieve corresponding retrieval document data based on a retrieval character outputted by the modality recognition module.

Specifically, the computer device may obtain a retrieval request inputted by a sample object as a sample retrieval request. The retrieval request may be configured for requesting data retrieval of knowledge or objects to be understood. For example, the retrieval request may be a question, a query text, a query image, or the like. The retrieval request may include a single-modality data request. The single-modality data request may include any one modality data such as text modality data, image modality data, or video modality data. The retrieval request may alternatively include a multi-modality data request. The multi-modality data request may include a combination of a plurality of modality data such as text modality data, image modality data, and video modality data. The retrieval request including text modality data and image modality data that have an association relationship may be referred to as a first sample retrieval request. The text modality data in the first sample retrieval request may be referred to as first sample text modality data, and the image modality data in the first sample retrieval request may be referred to as first sample image modality data. That the first sample text modality data and the first sample image modality data have an association relationship may mean that the first sample text modality data is a text question generated for the first sample image modality data. To be specific, the association relationship indicates that the first sample text modality data is a text question generated for the first sample image modality data. In other words, the first sample text modality data is configured for indicating retrieval of a part of data in the first sample image modality data. For example, the first sample image modality data is an image including a motorcycle. The first sample text modality data may be configured for retrieving the motorcycle in the first sample image modality data (e.g., retrieving a brand of the motorcycle in the first sample image modality data).
S102: Perform, by a prefix vector module, feature recognition on first sample image modality data to obtain a first image prefix vector.

Specifically, the computer device may generate, by the prefix vector module, a first image prefix vector according to first sample image modality data, to be specific, perform feature recognition on the first sample image modality data to obtain a first image prefix vector. The first image prefix vector generated by the prefix vector module may be configured to adjust and improve image feature recognition of the first sample image modality data, thereby improving the image feature recognition of the first sample image modality data. More granular visual representations of the first sample image modality data may be obtained by the first image prefix vector. To be specific, more image features of the first sample image modality data are extracted, so as to facilitate subsequent modality retrieval.

A prefix vector may be configured for enabling the modality recognition module to have multi-modality data recognition capability without changing original parameters of the modality recognition module. To be specific, the image prefix vector may include a prefix vector of image features. Since the modality recognition module has recognition capability for text modality data, the image prefix vector herein is configured for guiding the modality recognition module to recognize image features of the first sample image modality without changing original parameters of the modality recognition module, so that the modality recognition module adds recognition capability for image modality data. Finally, the modality recognition module has recognition capability for both image modality data and text modality data. The image features herein may refer to colors, textures, shapes, patterns, and the like.

In some embodiments, a specific manner in which the computer device generates, by the prefix vector module, a first image prefix vector according to the first sample image modality data may include: performing object cropping on the first sample image modality data to obtain object image data, and performing, by a feature extraction layer in the prefix vector module, feature extraction on the object image data to obtain an object image feature vector; performing, by a projection layer in the prefix vector module, linear transformation and dimension reduction processing on the object image feature vector to obtain a processed object image feature vector; and performing, by a prefix vector layer in the prefix vector module, vector summation of an adjusted feature vector in the prefix vector layer and the processed object image feature vector to obtain the first image prefix vector.

Specifically, the computer device may perform object cropping on the first sample image modality data to obtain object image data. Specifically, the computer device may perform object recognition on the first sample image modality data to determine a region where an object is located in the first sample image modality data, and crop the region where the object is located in the first sample image modality data to obtain object image data. For example, when the first sample image modality data includes a motorcycle, the computer device may perform object cropping on a region where the motorcycle is located in the first sample image modality data to obtain object image data corresponding to the motorcycle.

The prefix vector module includes a feature extraction layer, a projection layer, and a prefix vector layer. The computer device may transform the object image data to a target resolution, and further perform feature extraction on the object image data with the target resolution by using the feature extraction layer in the prefix vector module to obtain an object image feature vector. Further, the computer device may perform, by a projection layer in the prefix vector layer, linear transformation and dimension reduction processing on the object image feature vector to obtain a processed object image feature vector.

The projection layer in the prefix vector module may multiply the object image feature vector by a weight matrix in the projection layer by using a matrix multiplication operation, to obtain the processed object image feature vector. In this way, the dimension reduction processing of the object image feature vector may be implemented, thereby reducing the dimension of the object image feature vector. To be specific, a feature dimension of the processed object image feature vector is smaller than that of the original object image feature vector. The weight matrix in the projection layer of the prefix vector module may be learned during model training. The projection layer in the prefix vector module may act as a “bridge” to transform and transfer feature data between different layers, so that a neural network can adaptively adjust a data representation manner. To be specific, adaptation is provided for different model network layers, and convenience is brought for processing of subsequent model network layers.

Specifically, the prefix vector layer in the prefix vector module includes an adjusted feature vector. The adjusted feature vector may be obtained by random initialization, and a feature dimension of the adjusted feature vector may be the same as that of the processed object image feature vector. The computer device may perform, by a prefix vector layer in the prefix vector module, vector summation of an adjusted feature vector in the prefix vector layer and the processed object image feature vector to obtain the first image prefix vector. To be specific, the computer device may add the adjusted feature vector to the processed object image feature vector to obtain the first image prefix vector.

A quantity of prefix vector layers in the prefix vector module may be one or plural. When there are a plurality of prefix vector layers, adjusted feature vectors corresponding to the plurality of prefix vector layers respectively may be the same or different.
S103: Generate, by a modality recognition module, a first retrieval character according to the first image prefix vector, the first sample image modality data, and first sample text modality data.

The first retrieval character is configured for reflecting the first sample text modality data and the first sample image modality data. To be specific, the first retrieval character is text content for reflecting the first sample text modality data and the first sample image modality data.

Specifically, the modality recognition module may be configured to perform feature recognition on image modality data and text modality data respectively. The computer device may input the first image prefix vector, the first sample image modality data, and the first sample text modality data into the modality recognition module, and generate the first retrieval character by the modality recognition module. The first image prefix vector outputted by the prefix vector module may increase visual representations of the first sample image modality data at more granularities, thereby improving the accuracy of image feature recognition of the first sample image modality data, and further improving the generation accuracy of the first retrieval character. In some embodiments, the modality recognition module includes a visual representation sub-module and a language recognition sub-module. The visual representation sub-module is configured to perform feature recognition on image modality data, and the language recognition sub-module is configured to perform feature recognition on text modality data.

A specific manner in which the computer device generates, by the modality recognition module, a first retrieval character according to the first image prefix vector, the first sample image modality data, and the first sample text modality data may include:
performing, by the visual representation sub-module, feature extraction on the first sample image modality data to obtain an image modality feature vector, and performing attention feature extraction on the first image prefix vector and the image modality feature vector to obtain a visual representation vector; adding the first sample text modality data to a text slot in a data template, adding the visual representation vector to an image slot in the data template to obtain an added data template, and inputting the added data template into the language recognition sub-module; and performing, by the language recognition sub-module, feature extraction on the first sample text modality data in the text slot to obtain a text modality feature, and generating the first retrieval character according to the text modality feature and the visual representation vector in the image slot.

Specifically, the computer device may perform patching processing on the first sample image modality data by the visual representation sub-module to obtain a plurality of patched image data, and further perform feature extraction on the plurality of patched image data by a patch linear layer in the visual representation sub-module to obtain an image modality feature vector. The visual representation sub-module may include an attention mechanism, and perform attention feature extraction on the first image prefix vector and the image modality feature vector by the visual representation sub-module to obtain a visual representation vector. The first image prefix vector may be used as a prefix of the image modality feature vector and be inputted into the visual representation sub-module jointly, so as to adjust and improve image feature recognition of the image modality feature vector and obtain a multi-granularity visual representation vector. To improve adaptability between the visual representation vector outputted by the visual representation sub-module and the language recognition sub-module, the visual representation vector outputted by the visual representation sub-module may be inputted into an adaptive projection layer. The adaptive projection layer has different model parameters from the projection layer in the foregoing prefix vector module.

The computer device may perform linear transformation and dimension reduction processing on the visual representation vector by the adaptive projection layer to obtain a processed visual representation vector. By means of the adaptive projection layer, the visual representation vector may be mapped to a feature space of the language recognition sub-module, so as to facilitate the language recognition sub-module to better process the visual representation vector. A weight matrix in the adaptive projection layer may be learned and adjusted during a model training process. Further, the computer device may add the first sample text modality data to a text slot in a data template, and add the processed visual representation vector to an image slot in the data template to obtain an added data template. In the embodiments of the present disclosure, a data modality for instruction fine-tuning is constructed. The data template includes a text slot and an image slot. By inserting the visual representation feature and the first sample text modality data into predefined slots of the data template respectively, it is convenient for the language recognition sub-module to distinguish a first visual representation and the first sample text modality data.

The computer device may perform, by the language recognition sub-module, feature extraction on the first sample text modality data in the text slot to obtain a text modality feature. For example, word vector transformation is performed on the first sample text modality data, and a transformed word vector is taken as the text modality feature. Further, the computer device may generate, by the language recognition sub-module, the first retrieval character according to the text modality feature and the visual representation vector in the image slot. Specifically, the computer device may concatenate the text modality feature and the visual representation vector to obtain a concatenated feature vector, and generate, by the language recognition sub-module, the first retrieval character according to the concatenated feature vector. The language recognition sub-module may be a large language model structure. A large language model is a statistical model for predicting probabilities of a sequence of words in a text sequence, and trains large-scale text data to understand language and predict a next word in the sequence. For example, the language recognition sub-module may be a large language model structure such as a generative pre-training (GPT) network structure (a natural language processing model based on deep learning) and a bidirectional encoder representations from transformer (BERT) network structure (an unsupervised pre-trained language model for natural language processing tasks).

In some embodiments, to enable the language recognition sub-module to better adapt to a multi-modality retrieval scenario, an adaptive fine-tuning layer (the adaptive fine-tuning layer may adopt a LORA Adapter fine-tuning method) may be used to efficiently fine-tune the language recognition sub-module, so as to solve problems of excessive dependence of the language recognition sub-module on a generative model and over-fitting in the fine-tuning process during training of the added initial retrieval model. Specifically, the adaptive fine-tuning layer is implemented by introducing an additional adaptive fine-tuning layer (e.g., a linear layer) into the trained language recognition sub-module, and model parameters in the adaptive fine-tuning layer are fine-tuned by using training data of a multi-modality retrieval task. This method enables the added language recognition sub-module to better adapt to a specific task (e.g., the multi-modality retrieval task), and reduces excessive dependence on the original language recognition sub-module (e.g., the language recognition sub-module in an initial state in the trained initial retrieval model). The adaptive fine-tuning layer may be added into a self-attention layer in the language recognition sub-module. The self-attention layer in the language recognition sub-module is configured to perform self-attention feature extraction on the visual representation vector and the text modality feature.

In some embodiments, the visual representation sub-module includes N transformer layers, the prefix vector module includes N prefix vector layers corresponding to the N transformer layers, one transformer layer corresponds to one prefix vector layer, and the first image prefix vector includes image prefix vectors respectively outputted by the N prefix vector layers, N being a positive integer. Adjusted feature vectors corresponding to the N prefix vector layers may be different. Each prefix vector layer among the N prefix vector layers performs vector summation on the corresponding adjusted feature vector and the processed object image feature vector, to obtain image prefix vectors outputted respectively. A specific manner in which the computer device performs attention feature extraction on the first image prefix vector and the image modality feature vector to obtain a visual representation vector may include: obtaining an image transformation feature corresponding to an i^{th} transformer layer among the N transformer layers, when i=1, the image transformation feature corresponding to the first transformer layer being generated by the first transformer layer according to the image modality feature vector and the image prefix vector outputted by the first prefix vector layer, i being a positive integer less than or equal to N; generating, by an (i+1)^{th} transformer layer among the N transformer layers, an image transformation feature corresponding to the (i+1)^{th} transformer layer according to the image transformation feature corresponding to the i^{th} transformer layer and the image prefix vector outputted by an (i+1)^{th} prefix vector layer; and proceeding until an image transformation feature corresponding to an Nth transformer layer among the N transformer layers is obtained, and generating the visual representation vector according to the image transformation feature corresponding to the Nth transformer layer.

Specifically, the computer device may obtain an image transformation feature corresponding to an i^{th} transformer layer among the N transformer layers. In an example where i=1, the image transformation feature corresponding to the first transformer layer is generated by the first transformer layer according to the image modality feature vector and the image prefix vector outputted by the first prefix vector layer, where i is a positive integer less than or equal to N, the first prefix vector layer belongs to the N prefix vector layers included in the prefix vector module, and the first transformer layer corresponds to the first prefix vector layer. Specifically, in an example where the computer device obtains an image transformation feature corresponding to the first transformer layer, the computer device may multiply an image modality feature vector by a query weight vector in the first transformer layer by the first transformer layer, to obtain a processed image modality feature vector. Further, the computer device may perform self-attention feature extraction on the processed image modality feature vector and the image modality feature vector to obtain a third attention feature, and perform self-attention feature extraction on the processed image modality feature vector and the image prefix vector outputted by the first prefix vector layer to obtain a fourth attention feature.

Specifically, the computer device screens valid features from the fourth attention feature by using a gating layer corresponding to the first prefix vector layer, so as to obtain a valid fourth attention feature, thereby realizing denoising processing on the fourth attention feature and preventing invalid attention features in the fourth attention feature from interfering with the extraction of the image transformation feature corresponding to the first transformer layer. The N prefix vector layers have corresponding gating layers. The gating layer includes a gate function, and model parameters in the gating layer (e.g., function parameters of the gate function) may be learned and adjusted during model training. The computer device may sum the valid fourth attention feature and the third attention feature to obtain an attention feature sum corresponding to the first transformer layer, and then perform linear transformation on the attention feature sum corresponding to the first transformer layer by using a feed-forward neural network in the first transformer layer, to obtain the image transformation feature corresponding to the first transformer layer.

Further, the computer device may use an image transformation feature corresponding to an i^{th} transformer layer and an image prefix vector outputted by an (i+1)^{th} prefix vector layer as an input of an (i+1)^{th} transformer layer among the N transformer layers, and generate, by the (i+1)^{th} transformer layer among the N transformer layers, an image transformation feature corresponding to the (i+1)^{th} transformer layer according to the image transformation feature corresponding to the i^{th} transformer layer and the image prefix vector outputted by the (i+1)^{th} prefix vector layer. The (i+1)^{th} transformer layer is a next transformer layer of the i^{th} transformer layer. For example, when i=1, the (i+1)^{th} transformer layer is the second transformer layer among the N transformer layers. The (i+1)^{th} prefix vector layer belongs to the N prefix vector layers, and the (i+1)^{th} prefix vector layer corresponds to the (i+1)^{th} transformer layer. By analogy, the process proceeds until an image transformation feature corresponding to an Nth transformer layer among the N transformer layers is obtained, and the image transformation feature corresponding to the Nth transformer layer is determined as the visual representation vector.

In some embodiments, a specific manner in which the computer device generates an image transformation feature corresponding to an (i+1)^{th} transformer layer may include: multiplying, by the (i+1)^{th} transformer layer among the N transformer layers, the image transformation feature corresponding to the i^{th} transformer layer by a query weight vector in the (i+1)^{th} transformer layer to obtain a processed image transformation feature; performing self-attention feature extraction on the processed image transformation feature and the image prefix vector outputted by the (i+1)^{th} prefix vector layer to obtain a first attention feature; performing self-attention feature extraction on the processed image transformation feature and the image transformation feature corresponding to the i^{th} transformer layer to obtain a second attention feature; performing valid feature screening on the first attention feature to obtain a valid first attention feature, and summing the valid first attention feature and the second attention feature to obtain a total attention feature; and generating the image transformation feature corresponding to the (i+1)^{th} transformer layer according to the total attention feature.

Specifically, the computer device may use an image transformation feature corresponding to an i^{th} transformer layer and a query weight vector in an (i+1)^{th} transformer layer as an input of the (i+1)^{th} transformer layer among the N transformer layers, and multiply, by the (i+1)^{th} transformer layer among the N transformer layers, the image transformation feature corresponding to the i^{th} transformer layer by the query weight vector in the (i+1)^{th} transformer layer to obtain a processed image transformation feature. Each transformer layer among the N transformer layers has a corresponding query weight vector. The computer device may perform self-attention feature extraction on the processed image transformation feature and the image prefix vector outputted by the (i+1)^{th} prefix vector layer to obtain a first attention feature. The computer device may perform self-attention feature extraction on the processed image transformation feature and the image transformation feature corresponding to the i^{th} transformer layer to obtain a second attention feature.

Specifically, the computer device may screen valid features from the first attention feature by using a gating layer corresponding to the (i+1)^{th} prefix vector layer, so as to obtain a valid first attention feature. In this way, denoising processing on the first attention feature can be realized, and invalid attention features in the first attention feature can be prevented from interfering with the extraction of the image transformation feature corresponding to the (i+1)^{th} transformer layer. Further, the computer device may sum the valid first attention feature and the second attention feature to obtain a total attention feature. Linear transformation is performed on the total attention feature by using a feed-forward neural network in the (i+1)^{th} transformer layer, to obtain the image transformation feature corresponding to the (i+1)^{th} transformer layer.

In some embodiments, a specific manner in which the computer device performs self-attention feature extraction on the processed image transformation feature and the image prefix vector outputted by the (i+1)^{th} prefix vector layer to obtain a first attention feature may include: multiplying the image prefix vector outputted by the (i+1)^{th} prefix vector layer by a key weight vector corresponding to the (i+1)^{th} prefix vector layer to obtain a prefix key vector; multiplying the image prefix vector outputted by the (i+1)^{th} prefix vector layer by a value weight vector corresponding to the (i+1)^{th} prefix vector layer to obtain a prefix value vector; multiplying the processed image transformation feature by a transpose of the prefix key vector to obtain a first similarity vector; and multiplying the first similarity vector by the prefix value vector to obtain the first attention feature.

Specifically, the (i+1)^{th} transformer layer may include a key weight vector corresponding to the (i+1)^{th} prefix vector layer and a key weight vector corresponding to the i^{th} transformer layer. The computer device may multiply the image prefix vector outputted by the (i+1)^{th} prefix vector layer by the key weight vector corresponding to the (i+1)^{th} prefix vector layer in the (i+1)^{th} transformer layer to obtain a prefix key vector. Similarly, the (i+1)^{th} transformer layer may include a value weight vector corresponding to the (i+1)^{th} prefix vector layer and a value weight vector corresponding to the i^{th} transformer layer. The computer device may multiply the image prefix vector outputted by the (i+1)^{th} prefix vector layer by the value weight vector corresponding to the (i+1)^{th} prefix vector layer in the (i+1)^{th} transformer layer to obtain a prefix value vector. Further, the computer device may multiply the processed image transformation feature by a transpose of the prefix key vector to obtain an initial first similarity vector, obtain a ratio between the initial first similarity vector and a square root of a feature dimension of the image prefix vector, and then perform normalization processing on the ratio through a SoftMax function to obtain a first similarity vector. The SoftMax function may output continuous numbers into a number ranging from 0 to 1.

Further, the computer device may multiply the first similarity vector by the prefix value vector to obtain the first attention feature. The computer device calculates a prefix key vector (e.g., a K vector in a self-attention mechanism) and a prefix value vector (e.g., a V vector in the self-attention mechanism) according to a prefix vector outputted by an (i+1)^{th} prefix vector layer, and uses a processed image transformation feature as a query vector (e.g., a Q vector in the self-attention mechanism), so as to jointly calculate a self-attention feature.

In some embodiments, a specific manner in which the computer device performs self-attention feature extraction on the processed image transformation feature and the image transformation feature corresponding to the i^{th} transformer layer to obtain a second attention feature may include: multiplying the image transformation feature corresponding to the i^{th} transformer layer by a key weight vector corresponding to the i^{th} transformer layer to obtain an image key vector; multiplying the image transformation feature corresponding to the i^{th} transformer layer by a value weight vector corresponding to the i^{th} transformer layer to obtain an image value vector; multiplying the processed image transformation feature by a transpose of the image key vector to obtain a second similarity vector; and multiplying the second similarity vector by the image value vector to obtain the second attention feature.

Specifically, the (i+1)^{th} transformer layer includes a key weight vector corresponding to the i^{th} transformer layer. The computer device may multiply the image transformation feature corresponding to the i^{th} transformer layer by the key weight vector corresponding to the i^{th} transformer layer to obtain an image key vector. The key weight vector corresponding to the i^{th} transformer layer and the key weight vector corresponding to the (i+1)^{th} prefix vector layer may be the same or different. Similarly, the (i+1)^{th} transformer layer includes a value weight vector corresponding to the i^{th} transformer layer. The computer device may multiply the image transformation feature corresponding to the i^{th} transformer layer by the value weight vector corresponding to the i^{th} transformer layer to obtain an image value vector. Similarly, the value weight vector corresponding to the i^{th} transformer layer and the value weight vector corresponding to the (i+1)^{th} prefix vector layer may be the same or different. Further, the computer device may multiply the processed image transformation feature by a transpose of the image key vector to obtain an initial second similarity vector, obtain a ratio between the initial second similarity vector and a square root of a feature dimension of the processed image transformation feature, and then perform normalization processing on the ratio through a SoftMax function to obtain a second similarity vector. The computer device may multiply the second similarity vector by the image value vector to obtain the second attention feature.

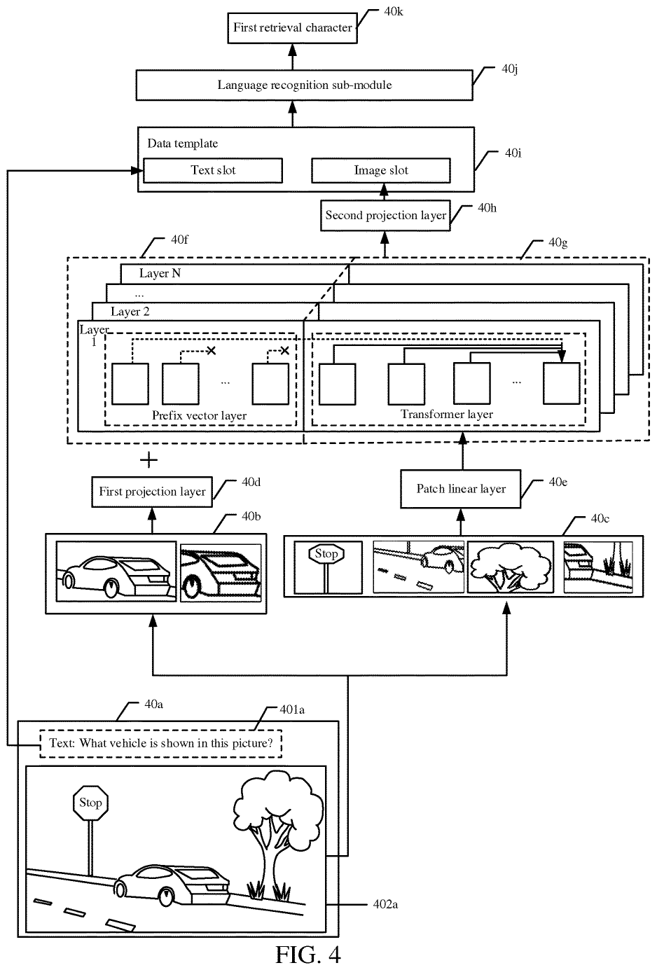

As show in FIG. 4, FIG. 4 is a schematic diagram of obtaining a first retrieval character according to an embodiment of the present disclosure. As shown in FIG. 4, in an example where first sample text modality data 401a included in a first sample retrieval request 40a is “What vehicle is shown in this picture” and first sample image modality data 402a included in the first sample retrieval request is an image containing a vehicle, the computer device may perform object cropping on the first sample image modality data to obtain object image data 40b. The computer device may perform feature extraction on the object image data 40b to obtain an object image feature vector, and perform, by a first projection layer 40d (e.g., a projection layer in the prefix vector module), linear transformation and dimension reduction processing on the object image feature vector to obtain a processed object image feature vector. Further, the computer device may perform, by a prefix vector layer 40f in the prefix vector module, vector summation of an adjusted feature vector in the prefix vector layer and the processed object image feature vector to obtain the first image prefix vector.

As shown in FIG. 4, a quantity of prefix vector layers 40f may be N. The adjusted feature vector in each prefix vector layer may be obtained by random initialization, and the adjusted feature vectors in different prefix vector layers may be different.

As shown in FIG. 4, the computer device may perform patching processing on the first sample image modality data 402a to obtain a plurality of patched image data 40c, and further perform feature extraction on the plurality of patched image data 40c by a patch linear layer 40e to obtain an image modality feature vector. The computer device may perform attention feature extraction on the first image prefix vector and the image modality feature vector by a transformer layer 40g in the visual representation sub-module to obtain a visual representation vector. A quantity of transformer layers 40g in the visual representation sub-module may be N. One prefix vector layer corresponds to one transformer layer, and the image prefix vector outputted by each prefix vector layer may be used as an input of the corresponding transformer layer. The first image prefix vector may be used as a prefix of the image modality feature vector and be inputted into the transformer layer in the visual representation sub-module jointly, so as to adjust and improve image feature recognition of the image modality feature vector and obtain a multi-granularity visual representation vector.

Taking the first transformer layer as an example, the computer device may control, by using a gate function, the image prefix vector outputted by the first prefix vector layer to participate in the self-attention calculation of the first transformer layer, which can reduce interference from invalid image prefix vectors and improve the accuracy and stability of visual representation vector extraction.

To improve adaptability between the visual representation vector outputted by the visual representation sub-module and the language recognition sub-module, the visual representation vector outputted by the visual representation sub-module may be inputted into a second projection layer 40h (e.g., an adaptive projection layer). Model parameters of the second projection layer 40h and the first projection layer 40d are different from each other. The computer device performs linear transformation and dimension reduction processing on the visual representation vector by the second projection layer 40h to obtain a processed visual representation vector. By means of the second projection layer 40h, the visual representation vector may be mapped to a feature space of a language recognition sub-module 40j, so as to facilitate the language recognition sub-module 40j to better process the visual representation vector. Further, the computer device may add the first sample text modality data 401a to a text slot in a data template 40i, add the processed visual representation vector to an image slot in the data template 40i to obtain an added data template, and input the added data template into the language recognition sub-module 40j.

The computer device may perform, by the language recognition sub-module 40j, feature extraction on the first sample text modality data in the text slot to obtain a text modality feature. For example, word vector transformation is performed on the first sample text modality data, and a transformed word vector is taken as the text modality feature. Further, the computer device may generate, by the language recognition sub-module 40j, a first retrieval character 40k according to the text modality feature and the visual representation vector in the image slot.
S104: Obtain, by a constraint decoding module, a first sample retrieval result associated with the first retrieval character from a pre-generated database.

The first sample retrieval result may refer to a retrieval result obtained by an initial modality model based on the first sample image modality data and the first sample text modality data, and the first sample retrieval result is a retrieval answer (e.g., an answer obtained by search) to the text question indicated by the first sample text modality data.

The association between the first retrieval character and the first sample retrieval result may mean that the first sample retrieval result includes the first retrieval character. Alternatively, the association between the first retrieval character and the first sample retrieval result may mean that the similarity between the first sample retrieval result and the first retrieval character is greater than a first similarity threshold. Alternatively, the association between the first retrieval character and the first sample retrieval result may mean that the similarity between a result identifier corresponding to the first sample retrieval result and the first retrieval character is greater than a second similarity threshold. The result identifier may refer to a number, a keyword, or a data identifier corresponding to the first sample retrieval result. For example, when the first sample retrieval result is document data, the data identifier may refer to a document identifier, namely a document name.

Specifically, the computer device may dynamically determine, by the constraint decoding module, any distinguishable fixed-length character in the document data according to the first retrieval character, use the determined character as a knowledge clue, and then retrieve the first sample retrieval result associated with the first sample retrieval request according to the knowledge clue. Compared with a static identifier such as a title or a uniform resource locator (URL), the knowledge clue has stronger flexibility and generalization in large-scale knowledge retrieval scenarios, which can improve the retrieval efficiency and accuracy of the first sample retrieval result.

In some embodiments, a specific manner in which the computer device retrieves, by the constraint decoding module, the first sample retrieval result associated with the first sample retrieval request according to the first retrieval character may include: querying, by a character obtaining interface in the constraint decoding module, a candidate character set matching the first retrieval character from the pre-generated database according to the first retrieval character, the pre-generated database including characters corresponding to P document data respectively, P being a positive integer; obtaining a matching probability between a candidate character in the candidate character set and the first retrieval character; determining, from the candidate character set, a candidate character having a maximum matching probability as a suffix character of the first retrieval character; and combining the first retrieval character and the suffix character to obtain a combined character sequence, and retrieving, according to the combined character sequence, the first sample retrieval result associated with the first sample retrieval request.

Specifically, the constraint decoding module may include a Beam Search decoding framework, which may introduce constraints during decoding of the first retrieval character to generate a dynamic “knowledge clue”, and ensure that the dynamic “knowledge clue” appears in only one piece of document data in the pre-generated database. The Beam Search decoding framework is an algorithm for searching an optimal solution in a search space, which performs search by selecting a group of candidate solutions with the highest probabilities at each time step, so as to find the most probable solution.

A character corresponding to document data may refer to a character for distinguishing the document data, and characters corresponding to different pieces of document data are unique. The pre-generated database may refer to a database for retrieval. The database may include various types of data such as document data and session data.

The constraint decoding module includes a character obtaining interface (e.g., a next character obtaining interface, GetNext interface), a validity verification interface (e.g., ValidDistinct interface), and a document retrieval interface (e.g., LookupDoc interface). The computer device may query, by a character obtaining interface in the constraint decoding module, a candidate character set matching the first retrieval character from the pre-generated database according to the first retrieval character.

To ensure the lookup efficiency and accuracy of the first sample retrieval result, the pre-generated database may be stored in an FM-Index database. The FM-Index database is a self-index structure for efficient processing of text data. The FM-Index database adopts a secondary storage manner for efficient sorting and access, and may efficiently locate occurrence positions of a pattern string in text by performing partial interval sampling on a suffix array (SA). The FM-Index database can restore original text in any range, and is generally used in scenarios for processing large-scale text data sets or requiring efficient text processing. The database integrates multiple technologies and algorithms to implement fast and efficient text retrieval and access. Meanwhile, three interfaces are encapsulated (e.g., the character obtaining interface, the validity verification interface, and the document retrieval interface). Each interface and the corresponding function are shown in Table 1.

TABLE 1

| Interface | Function | Return Type |
|---|---|---|
| GetNext | Obtain a set of next feasible tokens | Token set |
| ValidDistinct | Verify whether the current generated result | True/False |
| | uniquely exists in one document | |
| LookupDoc | Look up for a corresponding document | Document ID |
| | according to a “knowledge clue” | |

As shown in Table 1, the GetNext interface is configured to obtain a set of next feasible tokens (e.g., candidate characters matching the first retrieval character). The ValidDistinct interface is configured to verify whether the current generated result (e.g., the combined character sequence obtained by combining the first retrieval character and the suffix character) uniquely exists in one piece of document data in the pre-generated database. The LookupDoc interface is configured to look up for corresponding document data according to a “knowledge clue” (e.g., a valid combined character sequence).

The pre-generated database includes characters corresponding to P pieces of document data respectively, where P is a positive integer. The computer device may use the first retrieval character as a prefix condition, and search for all characters matching the prefix condition (e.g., the first retrieval character) from the pre-generated database to obtain a candidate character set. The computer device may obtain a matching probability between a candidate character in the candidate character set and the first retrieval character. For example, taking a target candidate character in the candidate character set as an example, the constraint decoding module may obtain a probability that the target candidate character is a next character of the first retrieval character, so as to obtain a matching probability between the target candidate character and the first retrieval character. The computer device may determine, from the candidate character set, a candidate character having a maximum matching probability as a suffix character of the first retrieval character, and combine the first retrieval character and the suffix character to obtain a combined character sequence. Further, the computer device may retrieve, according to the combined character sequence, the first sample retrieval result associated with the first sample retrieval request.

In some embodiments, a specific manner in which the computer device retrieves, according to the combined character sequence, the first sample retrieval result associated with the first sample retrieval request may include: verifying, by a validity verification interface in the constraint decoding module, validity of the combined character sequence to obtain a verification result; retrieving, by a document retrieval interface in the constraint decoding module, document data having the combined character sequence from the pre-generated database if the verification result indicates that the combined character sequence is valid; and determining the retrieved document data as the first sample retrieval result associated with the first sample retrieval request.

Specifically, the computer device may verify, by a validity verification interface in the constraint decoding module, validity of the combined character sequence to obtain a verification result. The computer device may verify whether the combined character sequence uniquely exists in one piece of document data in the pre-generated database, or whether a sequence length of the combined character sequence is greater than or equal to a sequence length threshold, so as to obtain a verification result. Only when the verification result indicates that the combined character sequence is valid, the computer device retrieves document data containing the combined character sequence from the pre-generated database via the document retrieval interface in the constraint decoding module, and determines the retrieved document data as the first sample retrieval result associated with the first sample retrieval request.

In particular, if the verification result indicates that the combined character sequence is invalid, the computer device continues to use the combined character sequence as a prefix condition via the character obtaining interface in the constraint decoding module, and search for all characters matching the combined character sequence from the pre-generated database to obtain a matching character set of the combined character sequence. Similarly, the computer device may obtain matching probabilities between characters in the matching character set of the combined character sequence and the combined character sequence. The computer device further generates a next combined character sequence according to the matching probabilities, and verifies validity of the next combined character sequence via the validity verification interface, until a valid combined character sequence is obtained.

It can be seen that the first retrieval character outputted by the language recognition sub-module may be the first predicted character, such as the first word outputted by the language recognition sub-module. The constraint decoding module may query candidate characters matching the first retrieval character from the pre-generated database according to the first retrieval character. It can be seen that the characters generated after the first retrieval character are all determined from characters included in the pre-generated database, which can ensure that the finally generated valid combined character sequence (e.g., the knowledge clue) appears and only appears in one piece of document data in the pre-generated database, thereby avoiding retrieval failure caused by the fact that the character finally generated by the language recognition sub-module does not exist in the pre-generated database, and ensuring the accuracy and efficiency of document data retrieval. Meanwhile, the constraint decoding module may dynamically generate a combined character sequence, and the finally generated valid combined character sequence may be any distinguishable fixed-length character in one piece of document data in the pre-generated database, which has stronger flexibility and generalization compared with a static identifier such as a title or a URL.

In the process of obtaining the valid combined character sequence (e.g., the knowledge clue), the GetNext interface is called in each decoding operation to determine a next feasible character sequence (e.g., the suffix character of the first retrieval character) from the pre-generated database according to the first retrieval character. The combined character sequence is generated according to the next feasible character sequence and the first retrieval character, and then the ValidDistinct interface is called to verify uniqueness of the generated combined character sequence. If the return value is True, it indicates that the current combined character sequence is a qualified knowledge clue, and the generation is stopped. Otherwise, the generation continues. Each subsequent operation of generating a combined character sequence is verified once via the ValidDistinct interface, until a valid combined character sequence (e.g., a qualified knowledge clue) is obtained or a sequence length of the generated combined character sequence reaches a stop condition (e.g., a sequence length threshold). The generated knowledge clue is used as a lookup condition of the LookupDoc interface, and corresponding document data may be obtained from the pre-generated database.

In some embodiments, a specific manner in which the computer device verifies, by a validity verification interface in the constraint decoding module, validity of the combined character sequence to obtain a verification result may include: the computer device may obtain, by the validity verification interface in the constraint decoding module, a sequence length of the combined character sequence, detect whether the sequence length is greater than or equal to a sequence length threshold, determine that the combined character sequence is valid if the sequence length is greater than or equal to the sequence length threshold, and generate a verification result for indicating that the combined character sequence is valid.

In some embodiments, the computer device obtains, from the pre-generated database, document data having the combined character sequence to obtain matched document data if the sequence length is less than the sequence length threshold. A quantity of the matched document data is obtained. It is determined that the combined character sequence is valid if the quantity of the matched document data is equal to a quantity threshold. A verification result for indicating that the combined character sequence is valid is generated. The quantity threshold may be 1, meaning that the matched document data uniquely exists in the pre-generated database. In this way, the retrieval accuracy of the first sample retrieval result can be ensured. If the quantity of the matched document data is not equal to the quantity threshold, it is determined that the combined character sequence is invalid, and the character obtaining interface continues to be called to generate a next combined character sequence until a valid combined character sequence is obtained. It can be seen that the knowledge-guided constraint decoding module may dynamically generate a correct “knowledge clue” (e.g., the valid combined character sequence) as a document identifier to retrieve the first sample retrieval result from the pre-generated database, which can improve the retrieval accuracy and efficiency of the first sample retrieval result.

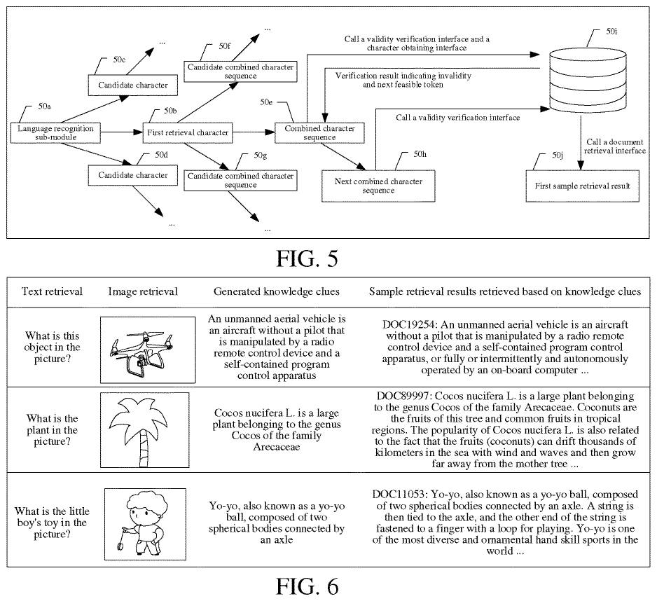

As shown in FIG. 5, FIG. 5 is a schematic diagram of retrieving a first sample retrieval result based on a first retrieval character according to an embodiment of the present disclosure. As shown in FIG. 5, a language recognition sub-module 50a may output a plurality of candidate characters (e.g., a candidate character 50c, a candidate character 50d, and a first retrieval character 50b), and the first retrieval character 50b may be the candidate character with the highest output probability among the plurality of candidate characters outputted by the language recognition sub-module 50a. Further, the computer device may call the character obtaining interface in the constraint decoding module to obtain all next feasible tokens of the first retrieval character 50b (e.g., a candidate character set matching the first retrieval character) from a pre-generated database 50i. The computer device may determine, from all next feasible tokens, the candidate character with the maximum matching probability with the first retrieval character as a suffix character of the first retrieval character, and combine the first retrieval character 50b and the suffix character of the first retrieval character to obtain a combined character sequence 50e. The first retrieval character may be combined with other candidate characters to obtain other candidate combined character sequences, such as a candidate combined character sequence 50f and a candidate combined character sequence 50g.

Further, the computer device may call the validity verification interface in the constraint decoding module to verify validity of the combined character sequence 50e (e.g., verify whether the combined character sequence 50e uniquely exists in one piece of document data in the pre-generated database 50i, or whether a sequence length of the combined character sequence 50e is greater than or equal to a sequence length threshold). If the validity verification interface returns a verification result indicating that the combined character sequence 50e is invalid, the computer device may use the combined character sequence 50e as a prefix condition via the character obtaining interface in the constraint decoding module, continue to obtain all next feasible tokens of the combined character sequence 50e, and further obtain a next combined character sequence 50h. Similarly, the computer device may verify validity of the next combined character sequence 50h via the validity verification interface in the constraint decoding module. When the validity verification interface returns a verification result indicating that the next combined character sequence 50h is valid, the computer device calls the document retrieval interface in the constraint decoding module to obtain a first sample retrieval result 50j from the pre-generated database 50i according to the next combined character sequence 50h.
S105: Adjust, according to a first reference retrieval result and the first sample retrieval result, model parameters corresponding to the prefix vector module and the constraint decoding module respectively to obtain an adjusted retrieval model.

Specifically, since the generative language model is trained, to be specific, the generative language model is pre-trained to meet a convergence condition, and the generative language model includes a modality recognition module, the model parameters in the modality recognition module are also trained completely. Therefore, the computer device may freeze the model parameters corresponding to the modality recognition module, so as to reduce the adjustment range of the model parameters. Even with limited labeled data, inherent knowledge in the trained generative language model can be effectively utilized to obtain a high-performance multi-modality retrieval model, thereby improving the training efficiency of the multi-modality retrieval model.

Since the prefix vector module and the constraint decoding module are newly added to the trained generative language model, the computer device may need to perform parameter adjustment on the prefix vector module and the constraint decoding module. Specifically, the computer device may determine a model loss value of the initial retrieval model according to the first reference retrieval result and the first sample retrieval result. Further, according to the model loss value, the model parameters respectively corresponding to the prefix vector module and the constraint decoding module are adjusted to obtain a multi-modality retrieval model. It can be seen that, in the embodiments of the present disclosure, by freezing the model parameters of the modality recognition module (e.g., not adjusting the model parameters of the modality recognition module) and only adjusting the model parameters respectively corresponding to the prefix vector module and the constraint decoding module, the adjustment range of the model parameters can be reduced, lightweight fine-tuning of the model parameters is realized, and the problem of catastrophic forgetting of the model parameters corresponding to the modality recognition module caused by adjusting the model parameters corresponding to the modality recognition module is avoided. In this way, the stability of model training can be ensured. Even with limited labeled data, the internal knowledge in the pre-trained initial retrieval model can be effectively utilized to obtain a high-performance multi-modality retrieval model, the model training load can be reduced, and the training efficiency of the multi-modality retrieval model can be improved.

The modality recognition module includes a visual representation sub-module. In order to finely tune the visual representation sub-module efficiently, an embodiment of the present disclosure proposes a visual object-aware prefix fine-tuning method. The prefix fine-tuning method fixes the original parameters of the visual representation sub-module, only keeps the parameters of the prefix vector module learnable, integrates an object image feature of a visual object in the first sample image modality data into a learnable prefix vector (e.g., the adjusted feature vector) in the prefix vector module, and adjusts and improves multi-granularity visual feature learning via the prefix vector module. In this way, the efficiency and stability of model training are ensured, and the problem of catastrophic forgetting of the visual representation sub-module caused by the scale of training data is avoided.

In some embodiments, a specific manner in which the computer device adjusts model parameters corresponding to the prefix vector module and the constraint decoding module respectively to obtain a multi-modality retrieval model may include: determining a model loss value of the initial retrieval model according to the first reference retrieval result and the first sample retrieval result. The computer device may compare the model loss value with a loss threshold. If the model loss value is greater than the loss threshold, derivation is performed on the model loss function of the initial retrieval model to obtain a derived model loss function. Parameter adjustment gradients corresponding to the prefix vector module and the constraint decoding module respectively are determined according to the derived model loss function and a gradient descent method. Further, the model parameters corresponding to the prefix vector module are adjusted according to the parameter adjustment gradient corresponding to the prefix vector module, and the model parameters of the constraint decoding module are adjusted according to the parameter adjustment gradient corresponding to the constraint decoding module to obtain a parameter-adjusted initial retrieval model. When the parameter-adjusted initial retrieval model satisfies a convergence condition, the training of the parameter-adjusted initial retrieval model is continued. When the parameter-adjusted initial retrieval model satisfies the convergence condition, the parameter-adjusted initial retrieval model is determined as the multi-modality retrieval model. The convergence condition may be that the model loss value is less than or equal to the loss threshold, or that a number of model training is greater than or equal to a target number.

The optimization training of the entire added initial retrieval model may adopt a Teacher-Forcing policy and a negative log-likelihood loss function. The Teacher-Forcing policy refers to predicting an r^{th} character according to the first r−1 predicted characters. The negative log-likelihood loss function is a common loss function in machine learning, especially in classification tasks, which is configured for measuring a difference between a model prediction result and a real result and help optimize the performance of a classification model.

The model loss function of the initial retrieval model may be shown in Formula (1).

$${ℒ}_{teacher} = - {\sum }_{r = 1}^{l} ( log P ( {y}_{r} \vert {y}_{< r} ; T ; V ; Θ ) ) \qquad ( 1 )$$

In Formula (1), r refers to a position of a predicted character. r=1, indicating the first character position. I refers to a total character length. yᵣ refers to a character at the r^{th} position. y_{<r} refers to characters at the first r−1 positions. T refers to an image modality feature of image modality data. V refers to a text modality feature of text modality data. Θ refers to a current model parameter in the initial retrieval model. log P(yᵣ|y_{<r}; T; V; Θ) refers to prediction of an output probability of yᵣ under y_{<r}, T, V, and Θ (e.g., a matching probability between yᵣ and y_{<r}), so as to predict an output probability of a character at each character position. [symbol] _{teacher} refers to the model loss function of the initial retrieval model.

In some embodiments, the trained multi-modality retrieval model may be applied to data retrieval of a single modality (e.g, any one of a text modality or an image modality) and also to data retrieval of multiple modalities (e.g., a combination of the text modality and the image modality). Specifically, the computer device may obtain a data retrieval request inputted by a business object. The data retrieval request includes retrieval text modality data and retrieval image modality data having an association relationship. The computer device may generate, by the prefix vector module in the multi-modality retrieval model, a retrieval image prefix vector according to the retrieval image modality data. By means of the modality recognition module in the multi-modality retrieval model, a target retrieval character associated with the data retrieval request is recognized according to the retrieval image prefix vector, the retrieval text modality data, and the retrieval image modality data. By means of the constraint decoding module in the multi-modality retrieval model, target retrieval document data associated with the data retrieval request is obtained according to the target retrieval character, and the target retrieval document data is outputted to the business object. In this way, the target retrieval document data may be retrieved accurately and quickly by the multi-modality retrieval model, the retrieval efficiency and accuracy of the target retrieval document data are improved, and the user experience is enhanced.

The multi-modality retrieval model in the embodiments of the present disclosure may alternatively be applied to scenarios such as video modality data and audio modality data. Specifically, the computer device may perform image transformation on the video modality data, call the multi-modality retrieval model, and perform data retrieval according to the transformed image modality data. Specifically, the computer device may perform text transformation on the audio modality data, call the multi-modality retrieval model, and perform data retrieval according to the transformed text modality data.

Embodiments of the present disclosure provide a generative retrieval method for multi-modality retrieval. The generative retrieval method uses an initial retrieval model as a model base, uses a data retrieval request (e.g., query content to be queried) inputted by a business object as an input, directly outputs an identifier (e.g., a knowledge clue) of best-matched document data in a pre-generated database by a constraint decoding module, and then retrieves corresponding retrieval document data, so as to provide accurate knowledge input for downstream tasks (e.g., knowledge-based question-and-answer tasks). In the embodiments of the present disclosure, the initial retrieval model is regarded as a virtual knowledge base, model parameters of the trained initial retrieval model are kept unchanged, and lightweight fine-tuning is performed on model parameters of a prefix vector module and a constraint decoding module of the initial retrieval model. In this way, even with limited training sample data, inherent knowledge of the initial retrieval model can be effectively utilized (e.g., the knowledge prior of the initial retrieval model is fully utilized), so that the prefix vector module and the constraint decoding module learn knowledge about data retrieval to obtain a multi-modality retrieval model. To be specific, a multi-modality retrieval model with superior retrieval performance may be obtained only with a small amount of training sample data. The multi-modality retrieval model in the embodiments of the present disclosure provides a generative multi-modality retrieval framework, which can achieve accurate knowledge retrieval performance.

Meanwhile, in the embodiments of the present disclosure, a knowledge-guided constraint decoding algorithm (e.g., the constraint decoding module) is configured for dynamically generating a “knowledge clue” (e.g., a valid combined character sequence). The “knowledge clue” may be any distinguishable fixed-length character string in any document data in the pre-generated database. The “knowledge clue” is used as a document identifier, and the knowledge clue has stronger flexibility and generalization in large-scale data retrieval scenarios compared with a static identifier such as a title or a URL. The embodiments of the present disclosure may be applied to a multi-modality data retrieval scenario. When a business object talks with a dialog system (e.g., a dialog robot), the multi-modality retrieval model in the embodiments of the present disclosure can endow the dialog system with multi-modality knowledge obtaining capability, so that the dialog system can perform data retrieval based on the multi-modality context of the current dialog context (e.g., the data retrieval request inputted by the business object) to obtain relevant common-sense or factual knowledge, and the multi-modality retrieval model generates a smarter and more accurate dialog reply.

The embodiments of the present disclosure use a system including a language recognition sub-module (e.g., a generative large language model) and a visual representation sub-module as a base, and introduce a prefix vector module and a constraint decoding module on this basis. Further, a visual object-aware prefix fine-tuning method is introduced by the prefix vector module to efficiently fine-tune the visual representation sub-module, so as to obtain visual representations with more granularities. Meanwhile, a correct “knowledge clue” is generated as a document identifier via the constraint decoding algorithm.

As shown in FIG. 6, FIG. 6 is a schematic diagram of generative retrieval performed by a multi-modality retrieval model according to an embodiment of the present disclosure. As shown in FIG. 6, when a data retrieval request inputted into a multi-modality retrieval model includes associated retrieval text modality data (“What is this object in the picture”) and retrieval image data (an image containing a flight device), the computer device may input the retrieval text modality data (“What is this object in the picture”) and the retrieval image data (an image containing an unmanned aerial vehicle) into the multi-modality retrieval model. A knowledge retrieval result generated by the multi-modality retrieval model is: “An unmanned aerial vehicle is an aircraft without a pilot that is manipulated by a radio remote control device and a self-contained program control apparatus.” Further, according to the generated knowledge retrieval result “An unmanned aerial vehicle is an aircraft without a pilot that is manipulated by a radio remote control device and a self-contained program control apparatus”, document data with a text identifier 19254 is queried from a pre-generated database, namely “An unmanned aerial vehicle is an aircraft without a pilot that is manipulated by a radio remote control device and a self-contained program control apparatus, or fully or intermittently and autonomously operated by an on-board computer . . . .”

As shown in FIG. 6, when a data retrieval request inputted into a multi-modality retrieval model includes associated retrieval text modality data (“What is the plant in the picture”) and retrieval image data (an image containing a plant), the computer device may input the retrieval text modality data (“What is the plant in the picture”) and the retrieval image data (an image containing a plant) into the multi-modality retrieval model. A knowledge retrieval result generated by the multi-modality retrieval model is: “Cocos nucifera L. is a large plant belonging to the genus Cocos of the family Arecaceae.” Further, according to the generated knowledge retrieval result “Cocos nucifera L. is a large plant belonging to the genus Cocos of the family Arecaceae”, document data with a text identifier 89997 is queried from a pre-generated database, namely “Cocos nucifera L. is a large plant belonging to the genus Cocos of the family Arecaceae. Coconuts are the fruits of this tree and common fruits in tropical regions. The popularity of Cocos nucifera L. is also related to the fact that the fruits (coconuts) can drift thousands of kilometers in the sea with wind and waves and then grow far away from the mother tree . . . ”

As shown in FIG. 6, when a data retrieval request inputted into a multi-modality retrieval model includes associated retrieval text modality data (“What is the little boy's toy in the picture”) and retrieval image data (an image showing a little boy playing with a toy), the computer device may input the retrieval text modality data (“What is the little boy's toy in the picture”) and the retrieval image data (an image showing a little boy playing with a toy) into the multi-modality retrieval model. A knowledge retrieval result generated by the multi-modality retrieval model is: “Yo-yo, also known as a yo-yo ball, composed of two spherical bodies connected by an axle.” Further, according to the generated knowledge retrieval result “Yo-yo, also known as a yo-yo ball, composed of two spherical bodies connected by an axle”, document data with a text identifier 11053 is queried from a pre-generated database, namely “Yo-yo, also known as a yo-yo ball, composed of two spherical bodies connected by an axle. A string is then tied to the axle, and the other end of the string is fastened to a finger with a loop for playing. Yo-yo is one of the most diverse and ornamental hand skill sports in the world . . . ”

In addition, the multi-modality retrieval model for multi-modality query in the embodiments of the present disclosure has relatively simple hardware environment requirements during use, and may be trained, deployed, and launched in an ordinary server environment. Details may be found in Table 2.

TABLE 2

| Operating System | Internal Memory | Language Environment |
|---|---|---|
| Linux | >16G | Python/c++ |

As shown in Table 2, an operating system of the multi-modality retrieval model may be Linux, which is a free and open-source UNIX-like operating system. An internal memory required by the multi-modality retrieval model is only greater than 16 GB, and a language environment of the multi-modality retrieval model is Python (a programming language) or C++ (a programming language).

The generative retrieval method proposed in the embodiments of the present disclosure can effectively implement multi-modality data retrieval. Compared with conventional methods, redundant retrieval pipelines and heavy training load can be avoided, while superior retrieval performance is achieved. Meanwhile, due to the powerful content understanding and generation capabilities of the large language model (e.g., the language recognition sub-module), the method has great potential in understanding complex retrieval requests (e.g., user queries). The validity of the generative retrieval method proposed in the embodiments of the present disclosure has been verified on a plurality of public multi-modality knowledge retrieval data sets, such as OKVQA-GS112K, OKVQA-WK21M, and ReMuQ data sets. Compared with an integrated retrieval method VRR, a sparse text retriever BM25, a dual-tower text retriever DPR, a cross-modality retriever CLIP, retrieval methods ReViz and ReViz-ICT based on single-stream multi-modality encoders, a generative text retriever CorpusBrain, etc., the multi-modality retrieval model in the embodiments of the present disclosure has higher performance, as shown in Table 3.

TABLE 3

| | Data Set | | | | | | | | |
|---|---|---|---|---|---|---|---|---|---|
| | OKVQA-GS112K | | | OKVQA-WK21M | | | ReMuQ | | |
| Evaluation indicator | P@5 | R@5 | P@10 | P@5 | R@5 | P@10 | P@1 | R@5 | P@10 |
| BM25 | 27.5 | 51.4 | 63 | 27.9 | 50.2 | 60.9 | 5.6 | 8.8 | 10.8 |
| DPR | 27.7 | 55.6 | 66.4 | 28.1 | 59.4 | 71.1 | 35.8 | 43.4 | 48.8 |
| CorpusBrain | 28.2 | 58.6 | 66.9 | — | — | — | — | — | — |
| CLIP | 11.1 | 34.5 | 50.5 | 9.7 | 29.8 | 43.0 | 19.4 | 40.2 | 49.3 |
| VRR | 39.4 | 71.5 | 81.5 | — | — | — | — | — | — |
| ReViz | 34.5 | 66.1 | 77.8 | 30.1 | 60.9 | 72.2 | 49.1 | 62.4 | 71.6 |
| ReViz-ICT | 41.7 | 73.4 | 83.2 | 31.4 | 61.9 | 72.6 | 62.1 | 76.2 | 83.3 |
| Multi-modality | 49.1 | 78.6 | 86.2 | 46.0 | 70.8 | 79.1 | 75.2 | 90.3 | 92.7 |
| retrieval model in the | | | | | | | | | |
| present disclosure | | | | | | | | | |

As shown in Table 3, the multi-modality retrieval model in the embodiments of the present disclosure has superior retrieval performance. P@5 in Table 3 refers to the accuracy of the top 5 retrieval document data outputted by the model. P@ 10 refers to the accuracy of the top 10 retrieval document data outputted by the model. P@1 refers to the accuracy of the first retrieval document data outputted by the model. R@5 in Table 3 refers to the recall rate of the top 5 retrieval document data outputted by the model.

In the embodiments of the present disclosure, the initial retrieval model has strong content understanding capability and language generation capability, and has great processing potential for data retrieval. Therefore, during the training process of the initial retrieval model, model parameters of the original modules (e.g., the modality recognition module) in the initial retrieval model remain unchanged. Only lightweight fine-tuning of the model parameters of the prefix vector module and the constraint decoding module is required, so that the prefix vector module and the constraint decoding module learn knowledge about data retrieval, to obtain the multi-modality retrieval model. In this way, the adjustment of the model parameters can be reduced, the training cost of the multi-modality retrieval model can be reduced, and the training efficiency of the multi-modality retrieval model can be improved. By keeping the model parameters of the original modules (e.g., modality recognition) in the initial retrieval model unchanged, the content understanding and generation capabilities of the initial retrieval model are reused, avoiding the problem of catastrophic forgetting of a generative language model caused by the update of training data, thereby ensuring the training stability of the multi-modality retrieval model. During the training process of the initial retrieval model, only lightweight fine-tuning of the constraint decoding module and the prefix vector module is required. Therefore, a large amount of sample data is not needed, which avoids the problem of low model training accuracy caused by insufficient sample data. To be specific, this is beneficial to improving the accuracy of model training, thereby improving the retrieval accuracy of a multi-modality model during the retrieval process.

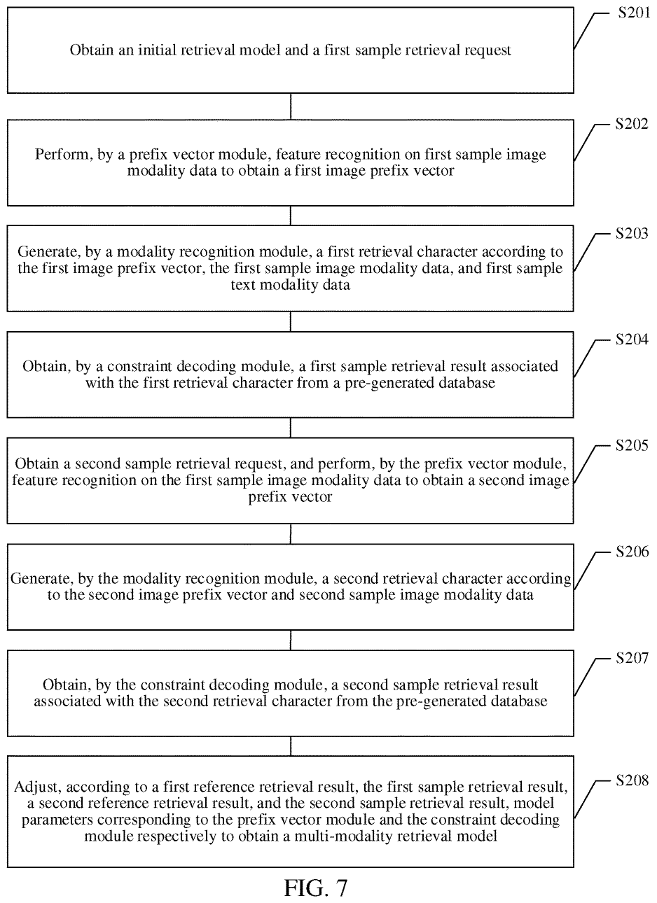

Further, referring to FIG. 7, FIG. 7 is a schematic flowchart of a multi-modality retrieval model generation method according to an embodiment of the present disclosure. As shown in FIG. 7, the method may be performed by any terminal device in FIG. 1, by the server 10 in FIG. 1, or jointly by the terminal devices and the server in FIG. 1. Devices configured to perform the multi-modality retrieval model generation method in the present disclosure may be collectively referred to as a computer device. The multi-modality retrieval model generation method may include, but is not limited to, the following operations:
S201: Obtain an initial retrieval model and a first sample retrieval request.
S202: Perform, by a prefix vector module, feature recognition on first sample image modality data to obtain a first image prefix vector.
S203: Generate, by a modality recognition module, a first retrieval character according to the first image prefix vector, the first sample image modality data, and first sample text modality data.
S204: Obtain, by a constraint decoding module, a first sample retrieval result associated with the first retrieval character from a pre-generated database.

Specifically, for the content of operations S201 to S204 in the embodiments of the present disclosure, refer to the content of the foregoing operations S101 to S104. Details are not described herein again in the embodiments of the present disclosure.
S205: Obtain a second sample retrieval request, and perform, by the prefix vector module, feature recognition on the first sample image modality data to obtain a second image prefix vector.

The second sample retrieval request includes second sample image modality data and a second reference retrieval result pre-labeled for the second sample retrieval request.

Specifically, if the second sample retrieval request includes second sample image modality data, the computer device may generate, by the prefix vector module, a second image prefix vector according to the second sample image modality data. Specifically, the computer device may perform object cropping on the second sample image modality data to obtain object image data corresponding to the second sample image modality data, and perform, by a feature extraction layer in the prefix vector module, feature extraction on the object image data corresponding to the second sample image modality data to obtain an object image feature vector corresponding to the second sample image modality data. The computer device may perform, by a projection layer in the prefix vector module, linear transformation and dimension reduction processing on the object image feature vector corresponding to the second sample image modality data to obtain a transformed object image feature vector. Vector summation of an adjusted feature vector in the prefix vector layer and the transformed object image feature vector is performed by a prefix vector layer in the prefix vector module to obtain the second image prefix vector.

Specifically, the computer device may train the added initial retrieval model by using the first sample retrieval request (e.g., multi-modality sample data) including the associated first sample image modality data and first sample text modality data, and may train the added initial retrieval model by using the second sample retrieval request including the second sample image modality data (e.g., single-modality sample data). The computer device may adopt both multi-modality sample data and single-modality sample data to train the added initial retrieval model. In this way, the trained multi-modality retrieval model may perform both single-modality data retrieval and multi-modality data retrieval.
S206: Generate, by the modality recognition module, a second retrieval character according to the second image prefix vector and second sample image modality data.

Specifically, the computer device may generate, by the modality recognition module and the language recognition sub-module, a second retrieval character according to the second image prefix vector and the second sample image modality data. The modality recognition module includes a visual representation sub-module. The computer device may call the visual representation sub-module to perform feature extraction on the second sample image modality data, so as to obtain an image feature corresponding to the second sample image modality data. Further, the computer device may call the visual representation sub-module to perform attention feature extraction on the image feature corresponding to the second sample image modality data and the second image prefix vector, so as to obtain a visual representation corresponding to the second sample image modality data. For the generation process of the visual representation corresponding to the second sample image modality data, refer to the content of operation S103. Details are not described herein again in the embodiments of the present disclosure. Further, the computer device may generate, by the language recognition sub-module, the second retrieval character according to the visual representation corresponding to the second sample image modality data.
S207: Obtain, by the constraint decoding module, a second sample retrieval result associated with the second retrieval character from the pre-generated database.

Specifically, the computer device may retrieve, by the constraint decoding module, a second sample retrieval result associated with the second sample retrieval request according to the second retrieval character. For details, refer to the content of operation S104. Details are not described herein again in the embodiments of the present disclosure.
S208: Adjust, according to a first reference retrieval result, the first sample retrieval result, a second reference retrieval result, and the second sample retrieval result, model parameters corresponding to the prefix vector module and the constraint decoding module respectively to obtain a multi-modality retrieval model.

Specifically, since the generative language model is trained, and the modality recognition module included in the trained generative language model is also completely trained, the computer device may freeze the model parameters corresponding to the modality recognition module. In this way, the adjustment range of modality parameters can be reduced, thereby reducing the model training load and improving the model training efficiency. Since the prefix vector module and the constraint decoding module are newly added to the trained generative language model, the computer device may determine a first retrieval loss of the initial retrieval model for the first sample retrieval request according to the first reference retrieval result and the first sample retrieval result. The computer device may determine a second retrieval loss of the initial retrieval model for the second sample retrieval request according to the second reference retrieval result and the second sample retrieval result. Further, the computer device may adjust model parameters corresponding to the prefix vector module and the constraint decoding module respectively according to the first retrieval loss and the second retrieval loss, to obtain a multi-modality retrieval model.

In some embodiments, the computer device may alternatively train the added initial retrieval model by using a third sample retrieval request including second sample text modality data. Specifically, if the third sample retrieval request includes second sample text modality data, the computer device generates, by the language recognition sub-module in the modality recognition module, a third retrieval character according to the second sample text modality data. A third sample retrieval result associated with the third retrieval character is obtained from the pre-generated database by the constraint decoding module. Further, the computer device may determine a first retrieval loss of the added initial retrieval model for the first sample retrieval request according to the first reference retrieval result and the first sample retrieval result. The computer device may determine a third retrieval loss of the initial retrieval model for the third sample retrieval request according to the third reference retrieval result and the third sample retrieval result. The computer device may adjust model parameters corresponding to the prefix vector module and the constraint decoding module respectively according to the first retrieval loss and the second retrieval loss, to obtain a multi-modality retrieval model.

In particular, the computer device may alternatively train the added initial retrieval model by using a mixed sample set including the first sample retrieval request, the second sample retrieval request, and the third sample retrieval request. In this way, the trained multi-modality retrieval model may perform both single-modality data retrieval and multi-modality data retrieval, thereby improving the applicability of the multi-modality retrieval model.

In the embodiments of the present disclosure, the initial retrieval model has strong content understanding capability and language generation capability, and has great processing potential for data retrieval. Therefore, during the training process of the initial retrieval model, model parameters of the original modules (e.g., the modality recognition module) in the initial retrieval model remain unchanged. Only lightweight fine-tuning of the model parameters of the prefix vector module and the constraint decoding module is required, so that the prefix vector module and the constraint decoding module learn knowledge about data retrieval, to obtain the multi-modality retrieval model. In this way, the adjustment of the model parameters can be reduced, the training cost of the multi-modality retrieval model can be reduced, and the training efficiency of the multi-modality retrieval model can be improved. By keeping the model parameters of the original modules (e.g., modality recognition) in the initial retrieval model unchanged, the content understanding and generation capabilities of the initial retrieval model are reused, avoiding the problem of catastrophic forgetting of a generative language model caused by the update of training data, thereby ensuring the training stability of the multi-modality retrieval model. During the training process of the initial retrieval model, only lightweight fine-tuning of the constraint decoding module and the prefix vector module is required. Therefore, a large amount of sample data is not needed, which avoids the problem of low model training accuracy caused by insufficient sample data. To be specific, this is beneficial to improving the accuracy of model training, thereby improving the retrieval accuracy of a multi-modality model during the retrieval process.

Further, referring to FIG. 8, FIG. 8 is a schematic structural diagram of a multi-modality retrieval model generation apparatus according to an embodiment of the present disclosure. The multi-modality retrieval model generation apparatus may be a computer program (including program code) running on a computer device. For example, the multi-modality retrieval model generation apparatus is application software. The multi-modality retrieval model generation apparatus may be configured to perform corresponding operations in the method provided by the embodiments of the present disclosure. As shown in FIG. 8, the multi-modality retrieval model generation apparatus may be any blockchain node in a blockchain network. The multi-modality retrieval model generation apparatus may include: an obtaining module 11, a first generation module 12, a second generation module 13, a first retrieval module 14, an adjustment module 15, a third generation module 16, a fourth generation module 17, a second retrieval module 18, a fifth generation module 19, a sixth generation module 20, an obtaining module 21, a seventh generation module 22, a recognition module 23, and an output module 24.

The obtaining module 11 is configured to obtain an initial retrieval model and obtain a first sample retrieval request, the initial retrieval model including a modality recognition module, a prefix vector module, and a constraint decoding module, and the first sample retrieval request including first sample text modality data and first sample image modality data mutually associated, and including a first reference retrieval result pre-labeled for the first sample retrieval request.

The first generation module 12 is configured to perform, by the prefix vector module, feature recognition on the first sample image modality data to obtain a first image prefix vector.

The second generation module 13 is configured to generate, by the modality recognition module, a first retrieval character according to the first image prefix vector, the first sample image modality data, and the first sample text modality data.

The first retrieval module 14 is configured to obtain, by the constraint decoding module, a first sample retrieval result associated with the first retrieval character from a pre-generated database.

The adjustment module 15 is configured to freeze model parameters corresponding to the modality recognition module, and adjust, according to the first reference retrieval result and the first sample retrieval result, model parameters corresponding to the prefix vector module and the constraint decoding module respectively to obtain a multi-modality retrieval model.

The first generation module 12 is specifically configured to:
perform object cropping on the first sample image modality data to obtain object image data, and perform, by a feature extraction layer in the prefix vector module, feature extraction on the object image data to obtain an object image feature vector;
perform, by a projection layer in the prefix vector module, linear transformation and dimension reduction processing on the object image feature vector to obtain a processed object image feature vector; and
perform, by a prefix vector layer in the prefix vector module, vector summation of an adjusted feature vector in the prefix vector layer and the processed object image feature vector to obtain the first image prefix vector.

The modality recognition module includes a visual representation sub-module and a language recognition sub-module. The second generation module 13 is specifically configured to:
perform, by the visual representation sub-module, feature extraction on the first sample image modality data to obtain an image modality feature vector, and perform attention feature extraction on the first image prefix vector and the image modality feature vector to obtain a visual representation vector;
add the first sample text modality data to a text slot in a data template, add the visual representation vector to an image slot in the data template to obtain an added data template, and input the added data template into the language recognition sub-module; and
perform, by the language recognition sub-module, feature extraction on the first sample text modality data in the text slot to obtain a text modality feature, and generate the first retrieval character according to the text modality feature and the visual representation vector in the image slot.

The visual representation sub-module includes N transformer layers, the prefix vector module includes N prefix vector layers corresponding to the N transformer layers, one transformer layer corresponds to one prefix vector layer, and the first image prefix vector includes image prefix vectors respectively outputted by the N prefix vector layers, N being a positive integer.

The second generation module 13 is further specifically configured to:
obtain an image transformation feature corresponding to an i^{th} transformer layer among the N transformer layers, when i=1, the image transformation feature corresponding to the first transformer layer being generated by the first transformer layer according to the image modality feature vector and the image prefix vector outputted by the first prefix vector layer, i being a positive integer less than or equal to N;
generate, by an (i+1)^{th} transformer layer among the N transformer layers, an image transformation feature corresponding to the (i+1)^{th} transformer layer according to the image transformation feature corresponding to the i^{th} transformer layer and the image prefix vector outputted by an (i+1)^{th} prefix vector layer; and
proceed until an image transformation feature corresponding to an Nth transformer layer among the N transformer layers is obtained, and generate the visual representation vector according to the image transformation feature corresponding to the Nth transformer layer.

The second generation module 13 is further specifically configured to:
multiply, by the (i+1)^{th} transformer layer among the N transformer layers, the image transformation feature corresponding to the i^{th} transformer layer by a query weight vector in the (i+1)^{th} transformer layer to obtain a processed image transformation feature;
perform self-attention feature extraction on the processed image transformation feature and the image prefix vector outputted by the (i+1)^{th} prefix vector layer to obtain a first attention feature;
perform self-attention feature extraction on the processed image transformation feature and the image transformation feature corresponding to the i^{th} transformer layer to obtain a second attention feature;
perform valid feature screening on the first attention feature to obtain a valid first attention feature, and sum the valid first attention feature and the second attention feature to obtain a total attention feature; and
generate the image transformation feature corresponding to the (i+1)^{th} transformer layer according to the total attention feature.

The second generation module 13 is further specifically configured to:
multiply the image prefix vector outputted by the (i+1)^{th} prefix vector layer by a key weight vector corresponding to the (i+1)^{th} prefix vector layer to obtain a prefix key vector;
multiply the image prefix vector outputted by the (i+1)^{th} prefix vector layer by a value weight vector corresponding to the (i+1)^{th} prefix vector layer to obtain a prefix value vector;
multiply the processed image transformation feature by a transpose of the prefix key vector to obtain a first similarity vector; and
multiply the first similarity vector by the prefix value vector to obtain the first attention feature.

The second generation module 13 is further specifically configured to:
multiply the image transformation feature corresponding to the i^{th} transformer layer by a key weight vector corresponding to the i^{th} transformer layer to obtain an image key vector;
multiply the image transformation feature corresponding to the i^{th} transformer layer by a value weight vector corresponding to the i^{th} transformer layer to obtain an image value vector;
multiply the processed image transformation feature by a transpose of the image key vector to obtain a second similarity vector; and
multiply the second similarity vector by the image value vector to obtain the second attention feature.

The first retrieval module 14 is specifically configured to:
query, by a character obtaining interface in the constraint decoding module, a candidate character set matching the first retrieval character from the pre-generated database according to the first retrieval character, the pre-generated database including characters corresponding to P document data respectively, P being a positive integer;
obtain a matching probability between a candidate character in the candidate character set and the first retrieval character;
determine, from the candidate character set, a candidate character having a maximum matching probability as a suffix character of the first retrieval character; and
combine the first retrieval character and the suffix character to obtain a combined character sequence, and retrieve, according to the combined character sequence, the first sample retrieval result associated with the first sample retrieval request. The first retrieval module 14 is further specifically configured to:

verify, by a validity verification interface in the constraint decoding module, validity of the combined character sequence to obtain a verification result;
retrieve, by a document retrieval interface in the constraint decoding module, document data having the combined character sequence from the pre-generated database if the verification result indicates that the combined character sequence is valid; and
determine the retrieved document data as the first sample retrieval result associated with the first sample retrieval request.

The first retrieval module 14 is further specifically configured to:
obtain, by the validity verification interface in the constraint decoding module, a sequence length of the combined character sequence;
determine that the combined character sequence is valid if the sequence length is greater than or equal to a sequence length threshold; and
generate a verification result for indicating that the combined character sequence is valid.

The first retrieval module 14 is further specifically configured to:
obtain, from the pre-generated database, document data having the combined character sequence to obtain matched document data if the sequence length is less than the sequence length threshold;
obtain a quantity of the matched document data, and determine that the combined character sequence is valid if the quantity of the matched document data is equal to a quantity threshold; and generate a verification result for indicating that the combined character

sequence is valid.

The adjustment module 15 is specifically configured to:
determine a model loss value of the initial retrieval model according to the first reference retrieval result and the first sample retrieval result;
determine parameter adjustment gradients corresponding to the prefix vector module and the constraint decoding module respectively according to the model loss value and a model loss function of the initial retrieval model; and
adjust the model parameters corresponding to the prefix vector module according to the parameter adjustment gradient corresponding to the prefix vector module, and adjust the model parameters of the constraint decoding module according to the parameter adjustment gradient corresponding to the constraint decoding module to obtain a multi-modality retrieval model.

The multi-modality retrieval model generation apparatus further includes:
a third generation module 16, configured to: obtain a second sample retrieval request, the second sample retrieval request including second sample image modality data and a second reference retrieval result pre-labeled for the second sample retrieval request; and perform, by the prefix vector module, feature recognition on the first sample image modality data to obtain a second image prefix vector;
a fourth generation module 17, configured to generate, by the modality recognition module, a second retrieval character according to the second image prefix vector and the second sample image modality data; and
a second retrieval module 18, configured to obtain, by the constraint decoding module, a second sample retrieval result associated with the second retrieval character from the pre-generated database.

The adjustment module 15 is further specifically configured to:

adjust, according to the first reference retrieval result, the first sample retrieval result, the second reference retrieval result, and the second sample retrieval result, the model parameters corresponding to the prefix vector module and the constraint decoding module respectively to obtain the multi-modality retrieval model.

The multi-modality retrieval model generation apparatus further includes:
a fifth generation module 19, configured to: obtain a third sample retrieval request, the third sample retrieval request including second sample text modality data and a third reference retrieval result pre-labeled for the third sample retrieval request; and generate, by the modality recognition module, a third retrieval character according to the second sample text modality data; and
a sixth generation module 20, configured to obtain, by the constraint decoding module, a third sample retrieval result associated with the third retrieval character from the pre-generated database.

The adjustment module 15 is further specifically configured to:

adjust, according to the first reference retrieval result, the first sample retrieval result, the third reference retrieval result, and the third sample retrieval result, the model parameters corresponding to the prefix vector module and the constraint decoding module respectively to obtain the multi-modality retrieval model.

The multi-modality retrieval model generation apparatus further includes:
an obtaining module 21, configured to obtain a data retrieval request inputted by a business object, the data retrieval request including retrieval text modality data and retrieval image modality data having an association relationship;
a seventh generation module 22, configured to perform, by a prefix vector module in the multi-modality retrieval model, feature recognition on the retrieval image modality data to obtain a retrieval image prefix vector;
a recognition module 23, configured to recognize, by a modality recognition module in the multi-modality retrieval model, the retrieval image prefix vector, the retrieval text modality data, and the retrieval image modality data to obtain a target retrieval character; and

an output module 24, configured to obtain, by a constraint decoding module in the multi-modality retrieval model, target retrieval document data associated with the data retrieval request according to the target retrieval character, and output the target retrieval document data to the business object.

In the embodiments of the present disclosure, the term “module” or “unit” refers to a computer program with a preset function or a part of the computer program and works, together with other related parts, to implement a preset target, and may be completely or partially implemented by using software, hardware (e.g., a processing circuit or a memory) or a combination thereof. Similarly, one processor (or a plurality of processors or memories) may be configured to implement one or more modules or units. In addition, each module or unit may be a part of an overall module or unit including a function of the module or unit. According to an embodiment of the present disclosure, modules in the multi-modality retrieval model generation apparatus shown in FIG. 8 may be separately or wholly combined into one or several units, or one (or more) of the units herein may further be divided into at least two subunits of smaller functions. In this way, the same operations may be implemented, and implementation of the technical effects of the embodiments of the present disclosure is not affected. The foregoing modules are divided based on logical functions. In actual application, a function of one module may be implemented by at least two units, or functions of at least two modules are implemented by one unit. In other embodiments of the present disclosure, the multi-modality retrieval model generation apparatus may alternatively include other units. In actual application, the functions may be cooperatively implemented by other units and may be cooperatively implemented by at least two units.

According to an embodiment of the present disclosure, the multi-modality retrieval model generation apparatus as shown in FIG. 8 may be constructed, and the multi-modality retrieval model generation method according to the embodiments of the present disclosure may be implemented, by running a computer program (including program code) that can perform the operations involved in the corresponding method shown in FIG. 3 on a general-purpose computer device such as a computer including a central processing unit (CPU), a random access memory (RAM), a read-only memory (ROM), and other processing elements and storage elements. The foregoing computer program may be recorded in, for example, a computer-readable recording medium, and may be loaded into the foregoing computer device by using the computer-readable recording medium, and run therein.

In the embodiments of the present disclosure, the initial retrieval model has strong content understanding capability and language generation capability, and has great processing potential for data retrieval. Therefore, during the training process of the initial retrieval model, model parameters of the original modules (e.g., the modality recognition module) in the initial retrieval model remain unchanged. Only lightweight fine-tuning of the model parameters of the prefix vector module and the constraint decoding module is required, so that the prefix vector module and the constraint decoding module learn knowledge about data retrieval, to obtain the multi-modality retrieval model. In this way, the adjustment of the model parameters can be reduced, the training cost of the multi-modality retrieval model can be reduced, and the training efficiency of the multi-modality retrieval model can be improved. By keeping the model parameters of the original modules (e.g., modality recognition) in the initial retrieval model unchanged, the content understanding and generation capabilities of the initial retrieval model are reused, avoiding the problem of catastrophic forgetting of a generative language model caused by the update of training data, thereby ensuring the training stability of the multi-modality retrieval model. During the training process of the initial retrieval model, only lightweight fine-tuning of the constraint decoding module and the prefix vector module is required. Therefore, a large amount of sample data is not needed, which avoids the problem of low model training accuracy caused by insufficient sample data. To be specific, this is beneficial to improving the accuracy of model training, thereby improving the retrieval accuracy of a multi-modality model during the retrieval process.

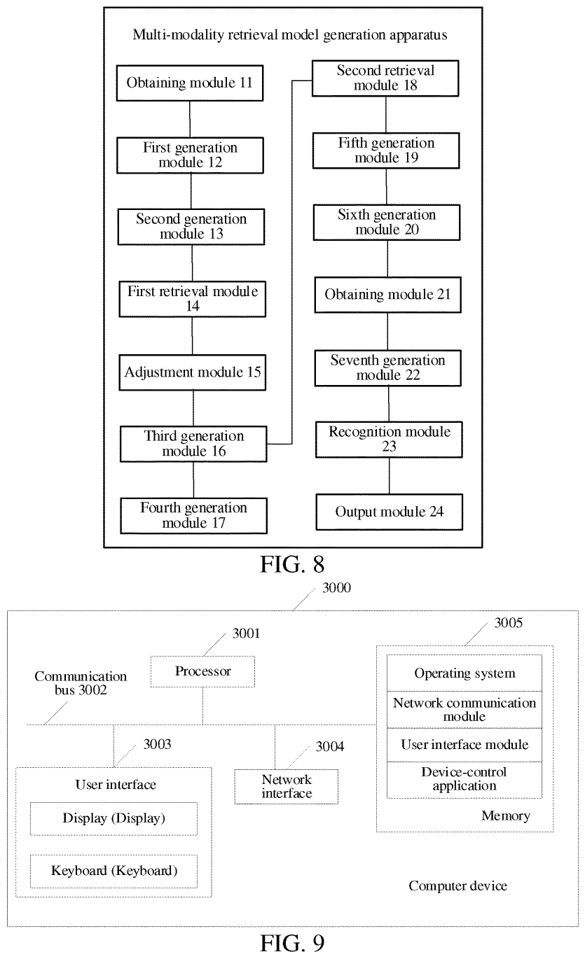

Further, referring to FIG. 9, FIG. 9 is a schematic diagram of a computer device according to an embodiment of the present disclosure. As shown in FIG. 9, a computer device 3000 may be a terminal device or a server in the foregoing embodiment corresponding to FIG. 2. The computer device 3000 may include: at least one processor 3001, e.g., a CPU, at least one network interface 3004, a user interface 3003, a memory 3005, and at least one communication bus 3002. The communication bus 3002 is configured to implement connection and communication between the components. The user interface 3003 may include a display and a keyboard. In some embodiments, the network interface 3004 may include a standard wired interface and a standard wireless interface (e.g., a WI-FI interface). The memory 3005 may be a high-speed RAM, or may be a non-volatile memory, for example, at least one magnetic disk memory. In some embodiments, the memory 3005 may alternatively be at least one storage apparatus that is located far away from the foregoing processor 3001. As shown in FIG. 9, the memory 3005 used as a computer storage medium may include an operating system, a network communication module, a user interface module, and a computer program-control application.

In the computer device 3000 shown in FIG. 9, the network interface 3004 is mainly configured to enable network communication between a second node device, a target relay server, and a target oracle server. The user interface 3003 is mainly configured to provide an input interface for a user. The processor 3001 may be configured to call the computer program-control application stored in the memory 3005, to implement the following operations:
obtaining an initial retrieval model, the initial retrieval model including a modality recognition module, a prefix vector module, and a constraint decoding module;
obtaining a first sample retrieval request, the first sample retrieval request including first sample text modality data and first sample image modality data mutually associated, and including a first reference retrieval result pre-labeled for the first sample retrieval request;
performing, by the prefix vector module, feature recognition on the first sample image modality data to obtain a first image prefix vector;
generating, by the modality recognition module, a first retrieval character according to the first image prefix vector, the first sample image modality data, and the first sample text modality data;
obtaining, by the constraint decoding module, a first sample retrieval result associated with the first retrieval character from a pre-generated database; and
adjusting, according to the first reference retrieval result and the first sample retrieval result, model parameters corresponding to the prefix vector module and the constraint decoding module respectively to obtain an adjusted retrieval model.

The computer device 3000 described in the embodiments of the present disclosure may alternatively perform the description of the multi-modality retrieval model generation method in the foregoing embodiment corresponding to FIG. 7. The computer device 3000 described in the embodiments of the present disclosure may alternatively perform the description of the multi-modality retrieval model generation apparatus in the foregoing embodiment corresponding to FIG. 8. Details are not described herein again. In addition, the beneficial effects of the same method are not described herein again.

In addition, an embodiment of the present disclosure further provides a computer-readable storage medium, the computer-readable storage medium has a computer program, executed by the aforementioned multi-modality retrieval model generation apparatus, stored therein, and the computer program includes program instructions. When the processor executes the program instructions, the description of the multi-modality retrieval model generation method in the foregoing embodiment corresponding to FIG. 3 or FIG. 7 can be performed. Therefore, details are not described herein again. In addition, the beneficial effects of the same method are not described herein again. For technical details that are not disclosed in the embodiments of the computer-readable storage medium included in the present disclosure, refer to the descriptions about the method embodiments of the present disclosure. As an example, the program instructions may be deployed on one computing device, or executed on a plurality of computing devices located at one position, or executed on a plurality of computing devices distributed at a plurality of positions and interconnected by using a communication network, and a blockchain system can be formed by a plurality of computing devices distributed at a plurality of positions and interconnected by using a communication network.

An aspect of the present disclosure provides a computer program product or computer program. The computer program product or computer program includes computer instructions, and the computer instructions are stored in a computer-readable storage medium. A processor of a computer device reads the computer instructions from the computer-readable storage medium, and the processor executes the computer instructions, so that the computer device may perform the description of the multi-modality retrieval model generation method in the foregoing embodiment corresponding to FIG. 3 or FIG. 7. Details are not described herein again. In addition, the beneficial effects of the same method are not described herein again.

Relevant data collection and processing in the present disclosure need to be strictly in accordance with the requirements of relevant laws and regulations when applied in practice, and the informed consent or separate consent (or legal basis) of the personal information subject needs to be obtained. Subsequent data use and processing need to be carried out within the scope of authorization of laws and regulations and the personal information subject. For example, when the present disclosure obtains data such as a retrieval request (e.g., a data retrieval request, a first sample retrieval request, or a second sample retrieval request) inputted by a sample object or a business object, it is required to obtain the informed consent or separate consent of the corresponding business object or sample object.

A person of ordinary skill in the art may understand that all or some of the processes of the method in the foregoing embodiments may be implemented by a computer program instructing relevant hardware. The computer program may be stored in a computer-readable storage medium. When the program is executed, the processes of the foregoing method embodiments are performed. The storage medium may include a magnetic disc, an optical disc, a ROM, a RAM, or the like.

What is disclosed above is merely exemplary embodiments of the present disclosure, and certainly is not intended to limit the scope of the claims of present disclosure. Therefore, equivalent variations made in accordance with the claims of present disclosure fall within the scope of the present disclosure.

What is claimed is:

1. A multi-modality retrieval model generation method, applied to a computer device, the method comprising:
obtaining an initial retrieval model, the initial retrieval model comprising a modality recognition module, a prefix vector module, and a constraint decoding module;
obtaining a first sample retrieval request, the first sample retrieval request comprising first sample text modality data, first sample image modality data, and a first reference retrieval result pre-labeled for the first sample retrieval request, wherein the first sample text modality data and the first sample image modality data are mutually associated;
performing, by the prefix vector module, feature recognition on the first sample image modality data to obtain a first image prefix vector;
generating, by the modality recognition module, a first retrieval character according to the first image prefix vector, the first sample image modality data, and the first sample text modality data;
obtaining, by the constraint decoding module, a first sample retrieval result associated with the first retrieval character from a pre-generated database; and
adjusting, according to the first reference retrieval result and the first sample retrieval result, model parameters corresponding to the prefix vector module and the constraint decoding module respectively to obtain an adjusted retrieval model.

2. The method according to claim 1, wherein performing, by the prefix vector module, feature recognition on the first sample image modality data to obtain the first image prefix vector comprises:
performing object cropping on the first sample image modality data to obtain object image data, and performing, by a feature extraction layer in the prefix vector module, feature extraction on the object image data to obtain an object image feature vector;
performing, by a projection layer in the prefix vector module, linear transformation and dimension reduction processing on the object image feature vector to obtain a processed object image feature vector; and
performing, by a prefix vector layer in the prefix vector module, vector summation of an adjusted feature vector in the prefix vector layer and the processed object image feature vector to obtain the first image prefix vector.

3. The method according to claim 1, wherein the modality recognition module comprises a visual representation sub-module and a language recognition sub-module; and
wherein generating, by the modality recognition module, the first retrieval character according to the first image prefix vector, the first sample image modality data, and the first sample text modality data comprises:
performing, by the visual representation sub-module, feature extraction on the first sample image modality data to obtain an image modality feature vector, and performing attention feature extraction on the first image prefix vector and the image modality feature vector to obtain a visual representation vector;
adding the first sample text modality data to a text slot in a data template, adding the visual representation vector to an image slot in the data template to obtain an added data template, and inputting the added data template into the language recognition sub-module; and
performing, by the language recognition sub-module, feature extraction on the first sample text modality data in the text slot to obtain a text modality feature, and generating the first retrieval character according to the text modality feature and the visual representation vector in the image slot.

4. The method according to claim 3, wherein the visual representation sub-module comprises N transformer layers, the prefix vector module comprises N prefix vector layers corresponding to the N transformer layers, and the first image prefix vector comprises image prefix vectors respectively outputted by the N prefix vector layers, a transformer layer among the N transformer layers corresponding to a prefix vector layer among the N prefix vector layers, N being a positive integer; and
wherein performing attention feature extraction on the first image prefix vector and the image modality feature vector to obtain the visual representation vector comprises:
obtaining an image transformation feature corresponding to an i^{th} transformer layer among the N transformer layers, i being a positive integer less than or equal to N, wherein when i=1, the image transformation feature corresponding to a first transformer layer is generated by the first transformer layer according to the image modality feature vector and the image prefix vector outputted by a first prefix vector layer;
generating, by an (i+1)^{th} transformer layer among the N transformer layers, an image transformation feature corresponding to the (i+1)^{th} transformer layer according to the image transformation feature corresponding to the i^{th} transformer layer and the image prefix vector outputted by an (i+1)^{th} prefix vector layer; and
proceeding until an image transformation feature corresponding to an N^{th} transformer layer among the N transformer layers is obtained, and generating the visual representation vector according to the image transformation feature corresponding to the N^{th} transformer layer.

5. The method according to claim 4, wherein generating, by the (i+1)^{th} transformer layer among the N transformer layers, the image transformation feature corresponding to the (i+1)^{th} transformer layer according to the image transformation feature corresponding to the i^{th} transformer layer and the image prefix vector outputted by the (i+1)^{th} prefix vector layer comprises:
multiplying, by the (i+1)^{th} transformer layer among the N transformer layers, the image transformation feature corresponding to the i^{th} transformer layer by a query weight vector in the (i+1)^{th} transformer layer to obtain a processed image transformation feature;
performing self-attention feature extraction on the processed image transformation feature and the image prefix vector outputted by the (i+1)^{th} prefix vector layer to obtain a first attention feature;
performing self-attention feature extraction on the processed image transformation feature and the image transformation feature corresponding to the i^{th} transformer layer to obtain a second attention feature;
performing valid feature screening on the first attention feature to obtain a valid first attention feature, and summing the valid first attention feature and the second attention feature to obtain a total attention feature; and
generating the image transformation feature corresponding to the (i+1)^{th} transformer layer according to the total attention feature.

6. The method according to claim 5, wherein performing self-attention feature extraction on the processed image transformation feature and the image prefix vector outputted by the (i+1)^{th} prefix vector layer to obtain the first attention feature comprises:
multiplying the image prefix vector outputted by the (i+1)^{th} prefix vector layer by a key weight vector corresponding to the (i+1)^{th} prefix vector layer to obtain a prefix key vector;
multiplying the image prefix vector outputted by the (i+1)^{th} prefix vector layer by a value weight vector corresponding to the (i+1)^{th} prefix vector layer to obtain a prefix value vector;
multiplying the processed image transformation feature by a transpose of the prefix key vector to obtain a first similarity vector; and
multiplying the first similarity vector by the prefix value vector to obtain the first attention feature.

7. The method according to claim 5, wherein performing self-attention feature extraction on the processed image transformation feature and the image transformation feature corresponding to the i^{th} transformer layer to obtain the second attention feature comprises:
multiplying the image transformation feature corresponding to the i^{th} transformer layer by a key weight vector corresponding to the i^{th} transformer layer to obtain an image key vector;
multiplying the image transformation feature corresponding to the i^{th} transformer layer by a value weight vector corresponding to the i^{th} transformer layer to obtain an image value vector;
multiplying the processed image transformation feature by a transpose of the image key vector to obtain a second similarity vector; and
multiplying the second similarity vector by the image value vector to obtain the second attention feature.

8. The method according to claim 1, wherein obtaining, by the constraint decoding module, the first sample retrieval result associated with the first retrieval character from the pre-generated database comprises:
querying, by a character obtaining interface in the constraint decoding module, a candidate character set matching the first retrieval character from the pre-generated database according to the first retrieval character, the pre-generated database comprising characters corresponding to P document data respectively, P being a positive integer;
obtaining a matching probability between a candidate character in the candidate character set and the first retrieval character;
determining, from the candidate character set, a candidate character having a maximum matching probability as a suffix character of the first retrieval character; and
combining the first retrieval character and the suffix character to obtain a combined character sequence, and obtaining, according to the combined character sequence, the first sample retrieval result associated with the first retrieval character from the pre-generated database.

9. The method according to claim 8, wherein obtaining, according to the combined character sequence, the first sample retrieval result associated with the first retrieval character from the pre-generated database comprises:
verifying, by a validity verification interface in the constraint decoding module, validity of the combined character sequence to obtain a verification result;
when the verification result indicates that the combined character sequence is valid, retrieving, by a document retrieval interface in the constraint decoding module, document data, the document data having the combined character sequence from the pre-generated database; and
determining the document data as the first sample retrieval result associated with the first retrieval character.

10. The method according to claim 9, wherein verifying, by the validity verification interface in the constraint decoding module, validity of the combined character sequence to obtain the verification result comprises:
obtaining, by the validity verification interface in the constraint decoding module, a sequence length of the combined character sequence;
determining, when the sequence length is greater than or equal to a sequence length threshold, that the combined character sequence is valid; and
generating a verification result, the verification result indicating that the combined character sequence is valid.

11. The method according to claim 10, further comprising:
obtaining, from the pre-generated database when the sequence length is less than the sequence length threshold, the document data having the combined character sequence to obtain matched document data;
obtaining a quantity of the matched document data, and determining, when the quantity of the matched document data is equal to a quantity threshold, that the combined character sequence is valid; and
generating the verification result, the verification result indicating that the combined character sequence is valid.

12. The method according to claim 1, wherein adjusting, according to the first reference retrieval result and the first sample retrieval result, the model parameters corresponding to the prefix vector module and the constraint decoding module respectively to obtain the adjusted retrieval model comprises:
determining a model loss value of the initial retrieval model according to the first reference retrieval result and the first sample retrieval result;
determining parameter adjustment gradients corresponding to the prefix vector module and the constraint decoding module respectively according to the model loss value and a model loss function of the initial retrieval model; and
adjusting the model parameters corresponding to the prefix vector module according to the parameter adjustment gradient corresponding to the prefix vector module, and adjusting the model parameters of the constraint decoding module according to the parameter adjustment gradient corresponding to the constraint decoding module to obtain a multi-modality retrieval model.

13. The method according to claim 1, further comprising:
obtaining a second sample retrieval request, the second sample retrieval request comprising second sample image modality data and a second reference retrieval result pre-labeled for the second sample retrieval request;
performing, by the prefix vector module, feature recognition on the first sample image modality data to obtain a second image prefix vector;
generating, by the modality recognition module, a second retrieval character according to the second image prefix vector and the second sample image modality data;
obtaining, by the constraint decoding module, a second sample retrieval result associated with the second retrieval character from the pre-generated database; and
wherein adjusting, according to the first reference retrieval result and the first sample retrieval result, the model parameters corresponding to the prefix vector module and the constraint decoding module respectively to obtain the multi-modality retrieval model comprises:
adjusting, according to the first reference retrieval result, the first sample retrieval result, the second reference retrieval result, and the second sample retrieval result, the model parameters corresponding to the prefix vector module and the constraint decoding module respectively to obtain the multi-modality retrieval model.

14. The method according to claim 1, further comprising:
obtaining a third sample retrieval request, the third sample retrieval request comprising second sample text modality data and a third reference retrieval result pre-labeled for the third sample retrieval request;
generating, by the modality recognition module, a third retrieval character according to the second sample text modality data;
obtaining, by the constraint decoding module, a third sample retrieval result associated with the third retrieval character from the pre-generated database; and
wherein adjusting, according to the first reference retrieval result and the first sample retrieval result, the model parameters corresponding to the prefix vector module and the constraint decoding module respectively to obtain the multi-modality retrieval model comprises:
adjusting, according to the first reference retrieval result, the first sample retrieval result, the third reference retrieval result, and the third sample retrieval result, the model parameters corresponding to the prefix vector module and the constraint decoding module respectively to obtain the multi-modality retrieval model.

15. The method according to claim 1, further comprising:
obtaining a data retrieval request inputted by a business object, the data retrieval request comprising retrieval text modality data and retrieval image modality data, the retrieval text modality data and the retrieval image modality data having an association relationship;
performing, by a prefix vector module in the multi-modality retrieval model, feature recognition on the retrieval image modality data to obtain a retrieval image prefix vector;
recognizing, by a modality recognition module in the multi-modality retrieval model, the retrieval image prefix vector, the retrieval text modality data, and the retrieval image modality data to obtain a target retrieval character; and
obtaining, by a constraint decoding module in the multi-modality retrieval model, target retrieval document data associated with the data retrieval request according to the target retrieval character, and outputting the target retrieval document data to the business object.

16. A multi-modality retrieval model generation apparatus, comprising a memory for storing instructions and a processor for executing the instructions to:
obtain an initial retrieval model, the initial retrieval model comprising a modality recognition module, a prefix vector module, and a constraint decoding module;
obtain a first sample retrieval request, the first sample retrieval request comprising first sample text modality data, first sample image modality data, and a first reference retrieval result pre-labeled for the first sample retrieval request, wherein the first sample text modality data and the first sample image modality data are mutually associated;
perform, by the prefix vector module, feature recognition on the first sample image modality data to obtain a first image prefix vector;
generate, by the modality recognition module, a first retrieval character according to the first image prefix vector, the first sample image modality data, and the first sample text modality data;
obtain, by the constraint decoding module, a first sample retrieval result associated with the first retrieval character from a pre-generated database; and
adjust, according to the first reference retrieval result and the first sample retrieval result, model parameters corresponding to the prefix vector module and the constraint decoding module respectively to obtain an adjusted retrieval model.

17. The multi-modality retrieval model generation apparatus according to claim 16,
wherein the processor, when being configured to perform, by the prefix vector module, feature recognition on the first sample image modality data to obtain the first image prefix vector, is configured to execute the instructions to:
perform object cropping on the first sample image modality data to obtain object image data, and perform, by a feature extraction layer in the prefix vector module, feature extraction on the object image data to obtain an object image feature vector;
perform, by a projection layer in the prefix vector module, linear transformation and dimension reduction processing on the object image feature vector to obtain a processed object image feature vector; and
perform, by a prefix vector layer in the prefix vector module, vector summation of an adjusted feature vector in the prefix vector layer and the processed object image feature vector to obtain the first image prefix vector.

18. The multi-modality retrieval model generation apparatus according to claim 16, wherein the modality recognition module comprises a visual representation sub-module and a language recognition sub-module; and
wherein the processor, when being configured to generate, by the modality recognition module, the first retrieval character according to the first image prefix vector, the first sample image modality data, and the first sample text modality data, is configured to execute the instructions to:
perform, by the visual representation sub-module, feature extraction on the first sample image modality data to obtain an image modality feature vector, and perform attention feature extraction on the first image prefix vector and the image modality feature vector to obtain a visual representation vector;
add the first sample text modality data to a text slot in a data template, add the visual representation vector to an image slot in the data template to obtain an added data template, and input the added data template into the language recognition sub-module; and
perform, by the language recognition sub-module, feature extraction on the first sample text modality data in the text slot to obtain a text modality feature, and generate the first retrieval character according to the text modality feature and the visual representation vector in the image slot.

19. The multi-modality retrieval model generation apparatus according to claim 16, wherein the processor, when being configured to obtain, by the constraint decoding module, the first sample retrieval result associated with the first retrieval character from the pre-generated database, is configured to execute the instructions to:
query, by a character obtaining interface in the constraint decoding module, a candidate character set matching the first retrieval character from the pre-generated database according to the first retrieval character, the pre-generated database comprising characters corresponding to P document data respectively, P being a positive integer;
obtain a matching probability between a candidate character in the candidate character set and the first retrieval character;
determine, from the candidate character set, a candidate character having a maximum matching probability as a suffix character of the first retrieval character; and
combine the first retrieval character and the suffix character to obtain a combined character sequence, and obtain, according to the combined character sequence, the first sample retrieval result associated with the first retrieval character from the pre-generated database.

20. A non-transitory computer readable medium storing a plurality of instructions, wherein the plurality of instructions, when executed by a processor, configure the instructions to:—A
obtain an initial retrieval model, the initial retrieval model comprising a modality recognition module, a prefix vector module, and a constraint decoding module;
obtain a first sample retrieval request, the first sample retrieval request comprising first sample text modality data, first sample image modality data, and a first reference retrieval result pre-labeled for the first sample retrieval request, wherein the first sample text modality data and the first sample image modality data are mutually associated;
perform, by the prefix vector module, feature recognition on the first sample image modality data to obtain a first image prefix vector;
generate, by the modality recognition module, a first retrieval character according to the first image prefix vector, the first sample image modality data, and the first sample text modality data;
obtain, by the constraint decoding module, a first sample retrieval result associated with the first retrieval character from a pre-generated database; and
adjust, according to the first reference retrieval result and the first sample retrieval result, model parameters corresponding to the prefix vector module and the constraint decoding module respectively to obtain an adjusted retrieval model.
